(19) United States
(12) Patent Application Publication
(10) Pub. No.: US 2020/0298677 A1
(43) Pub. Date: Sep. 24, 2020

(54) SYSTEMS, APPARATUS, AND METHODS TO ADJUST DIMMING ASSOCIATED WITH VEHICLE SUNROOFS

(71) Applicant: AISIN TECHNICAL CENTER OF AMERICA, INC., Northville, MI (US)

(72) Inventor: Shintaro KATSURA, Northville, MI (US)

(73) Assignee: AISIN TECHNICAL CENTER OF AMERICA, INC., Northville, MI (US)

(21) Appl. No.: 16/357,806

(22) Filed: Mar. 19, 2019

(51) Int. Cl. B60J 3/04; E06B 9/24

(52) U.S. Cl. CPC B60J 3/04; H04L 67/12; E06B 9/24

(57) ABSTRACT

Systems, apparatus, and methods to adjust dimming associated with vehicle sunroofs are disclosed. A disclosed sunroof dimming system for a vehicle includes a dimmable panel of a vehicle sunroof. The sunroof dimming system also includes a controller operatively coupled to the dimmable panel. The controller is configured to obtain data during operation of the vehicle. The controller is also configured to determine, based on the data, that a vehicle occupant will be exposed to an external light via the dimmable panel when the vehicle is at a first predicted location of a road. The controller is also configured to control the dimmable panel before the vehicle is at the first predicted location to reduce a brightness of the external light that the vehicle occupant will encounter.

### FIELD OF THE DISCLOSURE

This disclosure relates generally to vehicles and, more particularly, to systems, apparatus, and methods to adjust dimming associated with vehicle sunroofs.

### BACKGROUND

Motor vehicles typically employ sunroofs including dimmable panels (e.g., electrochromic panels) that have controllable dimming functionality. For example, a panel is configured to dim based on a voltage applied to the panel (e.g., when sunlight passing through the panel is relatively bright and/or intense). When in a dimmed state, such panels are advantageously used to block and/or otherwise reduce an amount of sunlight that enters a vehicle cabin, which prevents vehicle drivers from being dazzled by the sun as well as cools the vehicle cabin. As a result, these sunroof panels improve vehicle safety as well as driver comfort.

### SUMMARY

An aspect of the present disclosure includes a sunroof dimming system for a vehicle. The sunroof dimming system includes a dimmable panel of a vehicle sunroof. The sunroof dimming system also includes a controller operatively coupled to the dimmable panel. The controller is configured to obtain data during operation of the vehicle. The controller is also configured to determine, based on the data, that a vehicle occupant will be exposed to an external light via the dimmable panel when the vehicle is at a first predicted location of a road. The controller is also configured to control the dimmable panel before the vehicle is at the first predicted location to reduce a brightness of the external light that the vehicle occupant will encounter.

In a further aspect of the present disclosure, the dimmable panel includes multiple dimming bands positioned thereon and extending from a first side of the dimmable panel to a second side of the dimmable panel opposite the first side. The controller is to control one or more of the dimming bands to change a visual characteristic associated with the dimmable panel.

In a further aspect of the present disclosure, the dimming bands are rectangular.

In a further aspect of the present disclosure, the controller is to generate a dimming gradient via the dimming bands.

In a further aspect of the present disclosure, the dimming bands form a primary area of the panel and one or more secondary areas of the panel different from the primary area. The controller causes the primary area to be less transparent relative to the one or more secondary areas.

Another aspect of the present disclosure includes an apparatus including a sunroof controller. The sunroof controller is configured to determine that a dazzling event will occur while a vehicle is moving based on data associated with the vehicle. The dazzling event corresponds to a vehicle occupant being exposed to an external light via a sunroof panel of the vehicle. The sunroof controller is also configured to adjust dimming of the sunroof panel before the dazzling event occurs to prevent the vehicle occupant from being dazzled by the external light.

In a further aspect of the present disclosure, the sunroof controller is to calculate a trajectory associated with the vehicle. The sunroof controller is also to identify a predicted location of the vehicle that corresponds to a portion of the trajectory. The dazzling event is to occur when the vehicle is at the predicted location. The sunroof controller is also to control the sunroof panel before the vehicle reaches the predicted location.

In a further aspect of the present disclosure, the sunroof controller is to calculate the trajectory based on a predetermined route provided by a vehicle GPS or navigation system.

In a further aspect of the present disclosure, the sunroof controller is to calculate the trajectory based on a curvature or shape of a road on which the vehicle is moving.

In a further aspect of the present disclosure, the sunroof controller is to calculate a distance between an observed location of the vehicle and the predicted location of the vehicle. The sunroof controller is also to compare the distance to a threshold distance. The sunroof controller is also to control the sunroof panel when the distance is below the threshold distance.

In a further aspect of the present disclosure, the sunroof controller is to determine whether the vehicle deviates from the trajectory during the dazzling event. The sunroof controller is also to cease adjusting dimming of the sunroof panel if the vehicle deviates from the trajectory.

In a further aspect of the present disclosure, the sunroof controller is to determine a primary area of the sunroof panel that will be associated with a glare encountered by the vehicle occupant during the dazzling event. The sunroof panel including a secondary area different from the primary area that will not be associated with the glare during the dazzling event. The sunroof controller is also to dim the primary area by a greater degree relative to the secondary area.

In a further aspect of the present disclosure, the sunroof controller is to shift the primary area during the dazzling event based on movement of the vehicle relative to a light source generating the external light.

In a further aspect of the present disclosure, the sunroof controller is to control the sunroof panel to generate a dimming gradient thereon whereby a transparency of the sunroof panel varies across a portion of the dimming gradient.

Another aspect of the present disclosure includes an example tangible machine-readable medium including instructions that, when executed, cause a processor to at least determine that a dazzling event will occur while a vehicle is moving based on data associated with the vehicle. The dazzling event corresponds to a vehicle occupant being exposed to an external light via a sunroof panel of the vehicle. The instructions also cause the processor to adjust dimming of the sunroof panel before the dazzling event occurs to prevent the vehicle occupant from being dazzled by the external light.

In a further aspect of the present disclosure, the instructions cause the processor to calculate a trajectory associated with the vehicle. The instructions also cause the processor to identify a predicted location of the vehicle that corresponds to a portion of the trajectory. The dazzling event to occur when the vehicle is at the predicted location. The instructions also cause the processor to control the sunroof panel before the vehicle reaches the predicted location.

In a further aspect of the present disclosure, the instructions cause the processor to calculate the trajectory based on a predetermined route provided by a vehicle GPS or navigation system.

In a further aspect of the present disclosure, the instructions cause the processor to calculate the trajectory based on a curvature or shape of a road on which the vehicle is moving.

In a further aspect of the present disclosure, the instructions cause the processor to calculate a distance between an observed location of the vehicle and the predicted location of the vehicle. The instructions also cause the processor to compare the distance to a threshold distance. The instructions also cause the processor to control the sunroof panel when the distance is below the threshold distance.

In a further aspect of the present disclosure, the instructions cause the processor to determine whether the vehicle deviates from the trajectory during the dazzling event. The instructions also cause the processor to cease adjusting dimming of the sunroof panel if the vehicle deviates from the trajectory.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a view of an example vehicle in which examples disclosed herein can be implemented;

FIG. 2 is a partial view of the example vehicle of FIG. 1 and shows an example vehicle sunroof;

FIG. 3 is another view of the example vehicle of FIG. 1 and shows an example dazzling event encountered by a vehicle occupant;

FIG. 4 is an aerial view of the example vehicle of FIG. 1 and shows an example trajectory associated therewith;

FIGS. 5 and 6 are bottom-views of the example vehicle sunroof of FIG. 2 within an example vehicle cabin and show an example dimmable panel in accordance with the teachings of this disclosure;

FIG. 7 is a block diagram of an example sunroof dimming system to implement the examples disclosed herein;

FIG. 8 is a flow diagram representative of an example method that may be executed to implement the example sunroof dimming system of FIG. 7 to adjust sunroof dimming;

FIGS. 9 and 10 are flow diagrams representative of an example method that may be executed to implement the example sunroof dimming system of FIG. 7 to detect a vehicle condition; and

FIG. 11 is a block diagram of an example processor platform structured to execute instructions to carry out the example methods of FIGS. 8-10 and/or, more generally, to implement the example sunroof dimming system of FIG. 7.

The figures are not to scale. In general, the same reference numbers will be used throughout the drawing(s) and accompanying written description to refer to the same or like parts.

### DETAILED DESCRIPTION

Some known sunroof dimming systems are configured to dim a sunroof panel in response to a user touching the panel or otherwise providing input to a button or switch connected to the panel. Further, some other known sunroof dimming systems are configured to automatically dim a sunroof panel based on detected lighting conditions. Further still, some other known sunroof dimming systems are configured to automatically dim a sunroof panel in response to detecting when sunlight is passing through a sunroof panel and directed onto a vehicle driver, which may prevent the vehicle driver from being dazzled. However, such known sunroof dimming systems do not predict when sunlight will likely and/or imminently be dazzling the driver while driving. For example, sunlight may not be dazzling the driver when a vehicle is at a first location (e.g., a portion of a first road) but will likely dazzle, via the sunroof panel, the driver when the vehicle reaches a second location (e.g., a different portion of the first road or a second road different from the first road). As a result, these known sunroof dimming systems leave the driver unprotected from sunlight for a substantial time interval (e.g., 5 seconds, 3 seconds, 1 second, etc.) before detecting that the sunlight is dazzling, via the sunroof panel, the driver. That is, the vehicle may reach and/or pass the second location before these known sunroof dimming systems dim the sunroof panel.

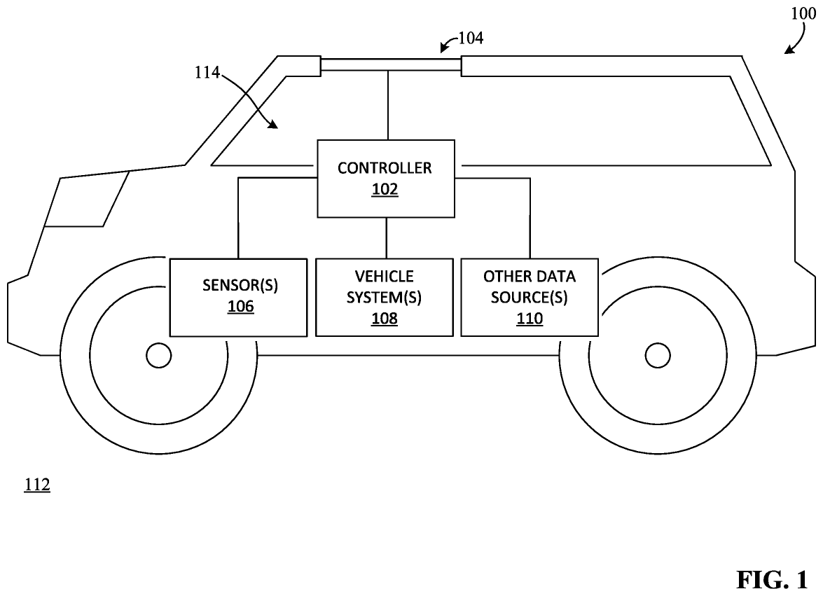

Systems, apparatus, and methods to adjust dimming associated with vehicle sunroofs are disclosed. Examples disclosed herein provide an example sunroof dimming system for a vehicle including an example controller (e.g., an electronic control unit (ECU) or module) and an example dimmable panel (e.g., an electrochromic panel) of a vehicle sunroof. The controller is operatively coupled to the dimmable panel to control dimming functionality thereof. For example, the controller adjusts an electrical parameter (e.g., voltage) applied or provided to the panel, thereby changing a visual characteristic (e.g., transparency, a tint, a color, etc.) of at least a portion of the panel. In particular, the disclosed controller is configured to determine that a vehicle occupant (e.g., a driver) will likely be exposed, via the panel, to an external light (e.g., sunlight) while the vehicle is moving along a trajectory (e.g., a predetermined trajectory) associated with the vehicle. For example, the vehicle occupant may not be initially exposed, via the panel, to the external light when vehicle is at a first location and/or driving along a particular road (e.g., a curved road). However, after performing a maneuver (e.g., a turn) and/or driving further along the road to reach a second or predicted location, the external light will be directed through the panel and onto the vehicle occupant (e.g., into the occupant's eye), which is sometimes referred to as a dazzling event. In particular, in response to predicting and/or otherwise determining that such a dazzling event is likely to occur, the controller advantageously adjusts dimming of the panel (e.g., via adjusting voltage provided to the panel) before the dazzling event occurs to reduce an intensity of the external light that will pass through the panel into the a vehicle cabin, as will be discussed in greater detail below in connection with FIGS. 1-11. For example, the controller controls the panel to decrease transparency and/or change tint or color of the entire panel or one or more areas thereof. In this manner, disclosed examples prevent the external light from dazzling and/or otherwise adversely affecting the vehicle occupant when the vehicle reaches or is near the predicted location. As a result, disclosed examples do not leave vehicle occupant unprotected from the external light for any period of time when the dazzling event occurs, which would have been unattainable using the above-mentioned known sunroof dimming systems.

Additionally, some disclosed examples provide example dimming bands (e.g., two or more) that are positioned on the sunroof panel and connected to the controller, for example, via one or more transmission or signal wires. For example, the disclosed bands are constructed at least partially of an electrochromic material. In particular, the dimming bands form and/or define a dimmable array and/or matrix that are controllable by the sunroof controller. In some examples, the dimming bands are sized and/or shaped such that the bands extend from a first side of the panel to a second side of the panel opposite the first side. In some such examples, each of the dimming bands is rectangular. In any case, the controller is configured to control dimming of each band independent of each other, for example, via adjusting a voltage provided to a particular band.

Additionally, during a dazzling event, some disclosed examples dim a primary area (e.g., one or more of the disclosed bands) of the sunroof panel while leaving a secondary area (e.g., one or more of the other disclosed bands) of the sunroof panel substantially clear, which allows a sufficient or comfortable amount of sunlight to pass through the sunroof panel and into the vehicle cabin while still protecting the vehicle occupant from a portion of the external light directed onto the vehicle occupant. In such examples, a portion of the external light is directed through the primary area of the panel and onto a portion (e.g., an eye) of a vehicle occupant, which may be undesirable to and/or dazzle the vehicle occupant if the primary area is not sufficiently dim. On the other hand, a different portion of the external light is directed through the secondary area of the panel and onto an interior of the vehicle cabin (i.e., not onto the vehicle occupant), which may be desirable to the vehicle occupant. In such examples, the controller is configured to determine the primary area and/or the secondary area based on the data associated with operation of the vehicle before the dazzling event occurs.

Additionally, in some examples, the controller controls the panel to generate (e.g., via the disclosed dimming bands) a dimming gradient, for example, corresponding to the primary area. In such examples, the transparency of the panel and/or the primary area varies across at least a portion of the dimming gradient. For example, the controller causes a first one of the bands to be less transparent relative to adjacent ones of bands. That is, bands further away from the first one of the bands are progressively less transparent relative to the first one of the bands. As a result, in such examples, the disclosed dimming gradient reduces a peripheral glare that may be encountered by the vehicle occupant and surrounding the first one of the bands during the dazzling event.

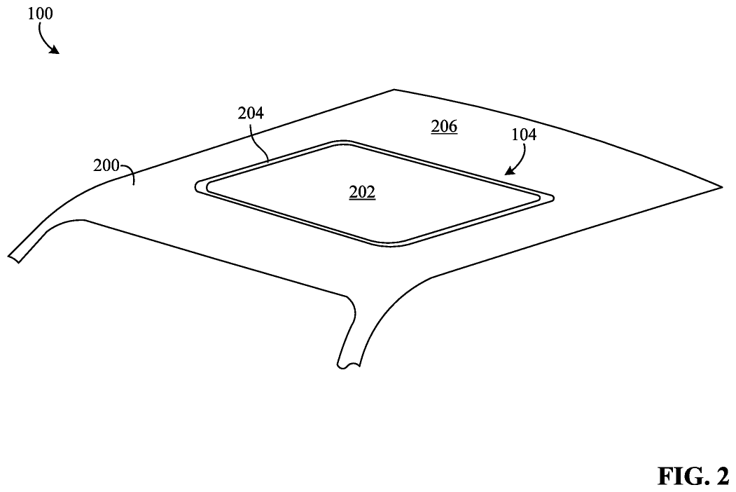

FIG. 1 is a view of an example vehicle (e.g., a car, a van, a truck, a sport utility vehicle (SUV), etc.) 100 in which examples disclosed herein can be implemented. According to the illustrated example of FIG. 1, the vehicle 100 includes an example controller 102, an example sunroof 104, one or more example sensors 106, one or more example vehicle system(s) 108, and one or more other data sources 110. The vehicle 100 of FIG. 1 is positioned on and/or moves along one or more example driving surface(s) 112 such as, for example, concrete, asphalt, dirt, sand, etc. As such, in some examples, the driving surface(s) 112 include one or more roads such as, for example, one or more streets, one or more avenues, one or more highways, one or more dirt roads, etc. In particular, the controller 102 of FIG. 1 is configured to detect one or more conditions associated with the vehicle 100 via the sensor(s) 106, the vehicle system(s) 108, and/or the other data source(s) 110. In response to such detection(s), the controller 102 controls the sunroof 104 based on the condition(s), as will be discussed further below in connection with FIGS. 2-11. In some examples, the controller 102 controls the sunroof 104 to change a visual characteristic of at least a portion of the sunroof 104 based on a detected lighting condition (e.g., in a vehicle cabin 114 and/or external to the vehicle 100) that is occurring or will occur while the vehicle 100 is moving along the driving surface(s) 112.

The controller 102 of FIG. 1 can be implemented, for example, using one or more ECUs operatively coupled to the vehicle 100. In particular, the controller 102 is communicatively coupled to the sensor(s) 106, the vehicle system(s) 108, and the other data source(s) 110 to receive data therefrom, for example, via a transmission or signal wire, a bus (e.g., controller area network (CAN)), radio frequency, etc. Similarly, the controller 102 is communicatively coupled to the sunroof 104 to control the sunroof 104, for example, via a transmission or signal wire, a bus, radio frequency, etc. In particular, the controller 102 generates one or more control signals or commands and provides the control signal(s) or command(s) to the sunroof 104, thereby controlling the sunroof 104. Additionally or alternatively, in some examples, the controller 102 draws electrical power from the vehicle 100 (e.g., via vehicle power source(s) such as a battery and/or an alternator) and provides the electrical power to the sunroof 104, thereby controlling the sunroof 104.

The vehicle sunroof 104 of FIG. 1 can be implemented, for example, using one of a panoramic sunroof, a pop-up sunroof, a spoiler or sliding sunroof, and/or any other appropriate vehicle sunroof. The vehicle sunroof 104 allows light to enter into the cabin 114 of the vehicle 100. In particular, the sunroof 104 has dimming functionality, which enables the controller 102 to adjust an amount of light that passes through the sunroof 104 and into the cabin 114. As previously mentioned, the sunroof 104 is communicatively coupled to the controller 102 to receive the control signal(s) or command(s) and/or the power therefrom. Additionally, in some examples, the sunroof 102 opens and/or closes in response to receiving such output from the controller 102. Accordingly, in such examples, the sunroof 104 includes one or more motor(s) (e.g., electric motors) communicatively coupled to the controller 102.

The sensor(s) 106 of FIG. 1 are connected to the vehicle 100 and/or sunroof controller 102 and configured to generate, obtain, and/or otherwise provide data to the controller 102 that is associated with one or more of the vehicle 100, the driving surface(s) 112, the vehicle occupant(s), and/or an external light. In some examples, the sensor(s) 106 include one or more example cameras configured to provide data associated with the vehicle occupant(s) such as, for example, one or more images indicative of a location (e.g., an observed location) of a facial feature (e.g., eye) of a vehicle occupant. For example, the controller 102 detects, via the camera(s), the location of the facial feature. Further, in some such examples, the controller 102 repeatedly (e.g., periodically, aperiodically, etc.) and/or continuously detects the facial feature location in this manner and/or otherwise tracks the facial feature location.

Additionally, in some examples, the sensor(s) 106 include one or more example GPS locators to provide data associated with the vehicle 100 such as, for example, positional data (e.g., GPS data) indicative of a location (e.g., an observed location and/or a predicted location) of the vehicle 100. For example, the controller 102 detects, via the GPS locator(s), the location of the vehicle 100. Further, in some such examples, the controller 102 repeatedly and/or continuously detects the vehicle location in this manner and/or otherwise tracks the vehicle location.

Additionally, in some examples, the sensor(s) 106 include one or more wheel speed sensors, one or more gyroscopes (e.g., yaw rate sensor(s)) and/or one or more accelerometers to provide other data associated with vehicle 100 such as, for example, data indicative of one or more of a speed of the vehicle 100, an acceleration (or a deceleration) of the vehicle 100, a yaw rate of the vehicle 100, and/or an orientation of the vehicle 100. For example, the controller 102 detects, via the wheel speed sensor(s), a speed of the vehicle 100. Further, in some such examples, the controller 102 repeatedly and/or continuously detects the vehicle speed in this manner and/or otherwise tracks the vehicle speed. In another example, the controller 102 detects, via the wheel speed sensor(s) and/or the accelerometer(s), an acceleration (or deceleration) of the vehicle 100. Further, in some such examples, the controller 102 repeatedly and/or continuously detects the vehicle acceleration (or vehicle deceleration) in this manner and/or otherwise tracks the vehicle acceleration (or the vehicle deceleration). In another example, the controller 102 detects, via one or more of the gyroscope(s), an orientation of the vehicle 100. Further, in some such examples, the controller 102 repeatedly and/or continuously detects the vehicle orientation in this manner and/or otherwise tracks the vehicle orientation.

Additionally, in some examples, the sensor(s) 106 include one or more light detectors (e.g., one of a photometer, a light meter, a spectrometer, etc.) to provide other data associated with the vehicle 100 and/or the external light such as, for example, an intensity of the external light within the vehicle cabin 114 and/or external to the vehicle 100. For example, the controller 102 detects, via the light detector(s), the intensity of the external light. Further, in some such examples, the controller 102 repeatedly and/or continuously detects the light intensity.

The vehicle system(s) 108 of FIG. 1 are connected the vehicle 100 and/or the controller 100 and configured to generate, obtain, and/or otherwise provide data to the controller 102 associated with the vehicle 100, the driving surface(s) 112, the vehicle occupant(s), and/or the external light. In some examples, the vehicle system(s) 108 include one or more of a camera monitoring system, a GPS, a navigation system, and/or any other appropriate vehicle system. For example, the controller 102 detects, via the camera monitoring system, the location of the facial feature in addition or alternatively to the sensor(s) 106. Further, in some such examples, the controller 102 detects, via the camera monitoring system, a location (e.g., an observed location) a light source (e.g., the sun) of the external light relative to the vehicle 100.

Additionally, in some examples, the controller 102 detects, via the GPS and/or the navigation system, the location of the vehicle 100 in addition or alternatively to the sensor(s) 106. In some examples, the controller 102 detects, via the GPS and/or the navigation system, one or more predetermined routes along which the vehicle 100 is traveling. In some such examples, the vehicle occupant may provide a destination to the GPS and/or the navigation system and, in response, the GPS and/or the navigation system generates the predetermined route(s) and provide such route(s) to the controller 102.

The other data source(s) 110 are connected to the vehicle 100 and/or the controller 102 and configured to generate, obtain, and/or otherwise provide data to the controller 102 that is associated with the driving surface(s) 112. In some examples, the other data source(s) 110 include one or more networks such as, for example, a CAN of the vehicle 100, the Internet, a satellite network, etc. In such examples, the other data source(s) 110 provide data to the controller 104 indicative of one or more road parameters (e.g., a distance or length, a curvature or shape, an inclination, etc.) and/or characteristics (e.g., road type) associated with the driving surface(s) 112. Similarly, in some examples, the controller 102 receives such data from the vehicle system(s) 108 such as, for example, the GPS and/or the navigation system.

Although FIG. 1 depicts particular sensor(s) 106, in some examples, the vehicle 100 includes any other appropriate sensor configured to provide data that facilitates and/or enables functionality of the vehicle 100 and/or the controller 102. Further, although FIG. 1 depicts particular vehicle system(s) 108, in some examples, the vehicle 100 includes any other appropriate vehicle system configured to provide data that facilitates and/or enables functionality of the vehicle 100 and/or the controller 102.

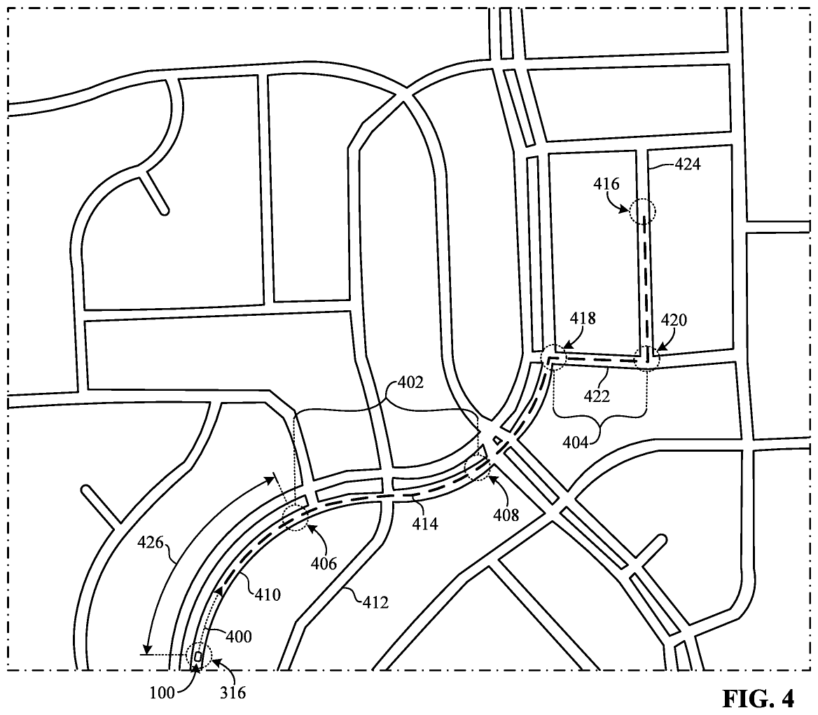

FIG. 2 is a partial view of the vehicle 100 and shows the sunroof 104 positioned on a vehicle roof 200. As such, the sunroof 104 is coupled to the roof 200, for example, via one or more example fasteners and/or one or more example fastening methods or techniques. According to the illustrated example of FIG. 2, the sunroof 104 includes one or more example dimmable panels 202, one of which is shown in this example. In some examples, at least a portion of the panel 202 includes electrochromic glass and/or one or more other suitable materials capable of changing at least a visual characteristic associated therewith in response to receiving the output from the controller 102. In particular, the panel 202 of FIG. 2 has one or more visual characteristic (e.g., one or more of a transparency, a tint, a color, etc.) associated therewith that change, for example, based on a voltage, a current, etc. that the controller 102 provides to the panel 202. For example, when the controller 102 decreases the voltage applied to the panel 202, the visual characteristic(s) change. That is, the controller 102 causes the panel 202 to change from a first state to a second state. In some examples, when in the second state, at least a portion of the panel 202 is less transparent relative to the first state and/or otherwise allows less light to pass therethrough compared to the first state. Although FIG. 4 depicts the sunroof 104 having the single panel 202, in some examples, the sunroof 104 is implemented differently (e.g., having more than one sunroof panel).

As previously mentioned, in some examples, the sunroof panel 202 is configured to move between a first position (e.g., a closed position) in which the sunroof 104 is substantially closed and a second position (e.g., an open position) the sunroof 104 in which the sunroof 104 is substantially open. For example, the controller 102 may control (e.g., via a motor) the sunroof panel 202 to lift, tilt, slide, etc. As shown in FIG. 2, the panel 202 is in the first position thereof. In such examples, the panel 202 substantially prevents fluid(s) (e.g., air, water, etc.) from entering the vehicle cabin 114 when the panel 202 is in the first position. For example, the sunroof 104 may include one or more seals (e.g., trim seal(s)) 204 operatively coupled to and/or interposed between the panel 202 and the roof 200 such that a fluid seal is formed when the panel 202 is in the first position. Conversely, in some examples, the panel 202 allows at least some of the fluid(s) to enter the cabin 114 when the panel 202 is in the second position. In some examples, the panel 202 partially defines an exterior surface 206 of the vehicle 100, as shown in FIG. 2.

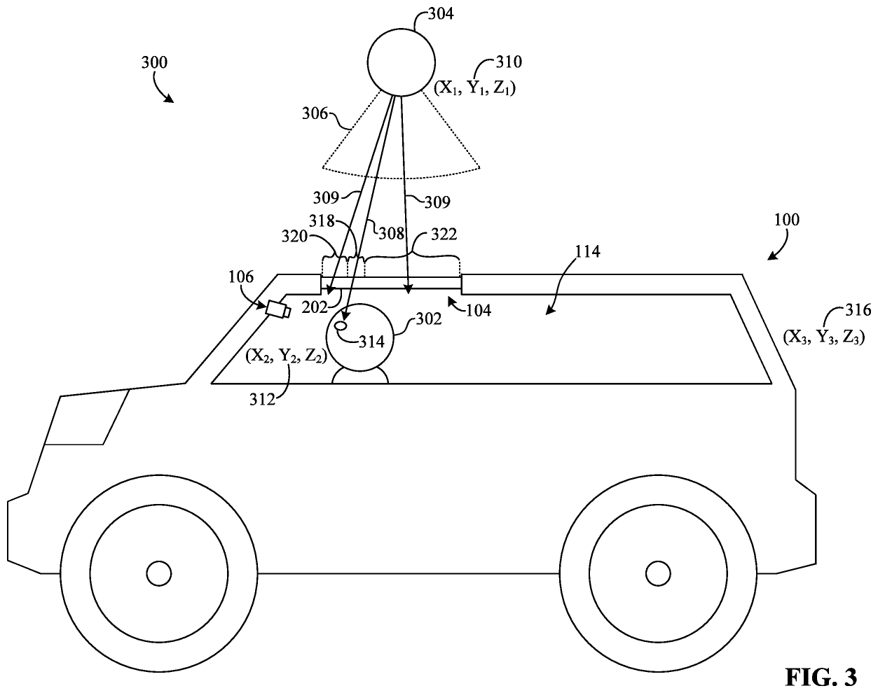

FIG. 3 is another view of the vehicle 100 of FIG. 1 and shows a first example dazzling event 300 encountered by a vehicle occupant (e.g., a driver) 302. According to the illustrated example of FIG. 3, an example light source (e.g., the sun) 304 external to the vehicle 100 is affecting the first occupant 302 of the vehicle 100 via the sunroof panel 202 (e.g., the first occupant 302 is encountering a glare). As such, a first example condition associated with the vehicle 100 of FIG. 3 corresponds to the vehicle occupant 302 being exposed, via the sunroof panel 202, to at least a portion of an example light 306 generated by and/or emitted from the light source 304. In particular, the light 306 has a primary portion (e.g., one or more beams) 308 that is passing through the panel 202 into the vehicle cabin 114 and causing the vehicle occupant 302 to encounter a glare, which may dazzle the vehicle occupant 302. That is, the primary portion 308 of the light 306 is directed through the sunroof panel 202 and onto the vehicle occupant 302 and/or is otherwise causing the vehicle cabin 114 to become relatively bright and/or hot. As a result, the primary portion 308 of the external light 306 may dazzle and/or transfers heat the vehicle occupant 302, which may be undesirable to and/or adversely affect (e.g., distract, irritate, etc.) the vehicle occupant 302. Thus, the primary portion 308 of the light 306 is considered to be adversely affecting the vehicle occupant 302.

On the other hand, in some examples, the light 306 of FIG. 3 also has a secondary portion (e.g., one or more beams) 309, different from the primary portion 306, that is passing through the panel 202 and onto an interior surface of the vehicle cabin 114. Unlike the primary portion 308, the secondary portion 309 of the light 306 is not adversely affecting the vehicle occupant 302. That is, the secondary portion 309 is not directed onto the vehicle occupant 302, and the vehicle occupant 302 is not encountering a substantial glare caused by the secondary portion 309. The light 306 and/or the portion(s) 308, 309 thereof is/are sometimes referred to as external light.

In some examples, the controller 102 detects this first condition of the vehicle 100 via the sensor(s) 106, the vehicle system(s) 108, and/or the other data source(s) 110 and, thus, detects that the first dazzling 300 event is occurring. In response to such a detection, the controller 102 controls the panel 202 to change from the first state to the second state, thereby reducing a brightness of at least a portion of the light 306 encountered by the vehicle occupant 302. Additionally, in examples where the first dazzling event 300 has not yet occurred, the controller 102 predicts and/or otherwise determines that the dazzling event 300 will likely occur while the vehicle 100 is moving and, in response, controls the panel 202 to change from the first state to the second state, as discussed further below.

To facilitate predictions and/or detections of the dazzling event 300 (e.g., and or more other dazzling events), the controller 102 detects: (1) a first example observed location 310 of the light source 304; (2) a second example observed location 312 of a facial feature (e.g., an eye) 314 of the vehicle occupant 302; and (3) a third example observed location 316 of the vehicle 100. Further, in some examples, the controller 102 also detects an observed orientation of the vehicle 100. As such, the observed locations 310, 312, 316 and/or the vehicle orientation of FIG. 3 define an example data set of interest corresponding to the first dazzling event 300, which is stored in the controller 102 in some examples. Thus, one or more of such data sets of interest exist that correspond to the first dazzling event (and/or one or more other dazzling events) and/or otherwise indicate to the controller 102 that a dazzling event is occurring. These data sets of interest are sometimes referred to as criteria, which the controller 102 advantageously uses to make prediction(s) and/or detection(s) of dazzling event(s).

In some examples, the sunroof panel 202 includes an example primary area 318 and one or more example secondary area(s) 320, 322 (two of which are shown in this example). The primary area 318 of FIG. 3 corresponds to the primary light portion 308 of the light 306 and/or is otherwise associated with the glare encountered by the vehicle occupant 302. That is, the primary portion 308 is passing through the primary area 318 and into the vehicle cabin 114. In particular, the primary area 318 is positioned between and/or aligned to the light source 304 and the facial feature 314. Further, each of the secondary area(s) 320, 322 of FIG. 3 corresponds to the secondary portion 309 of the light 306 and/or is otherwise not associated with the glare encountered by the vehicle occupant 302. That is, the secondary portion 309 is passing through the secondary area(s) 320, 322 and into the vehicle cabin 114. However, unlike the primary area 318, the secondary area(s) 320, 322 are not positioned between and/or aligned to the light source 304 and the facial feature 314. For example, the secondary area(s) 320, 322 are considered to be offset relative to a line extending from a portion (e.g., a center) of the light source 304 and a portion (e.g., a center) of the facial feature 314.

In particular, in such examples, the controller 102 controls the primary area 318 of the sunroof panel 202 in a manner that is different relative to the secondary areas 320, 322 of the sunroof panel 202. For example, the controller 102 dims the primary area 318 by a greater degree relative to the secondary area(s) 320, 322. In other words, in such examples, the primary area 318 is less transparent relative to the secondary area(s) 320, 322. As a result, in such examples, the controller 102 reduces the glare encountered by the vehicle occupant 302 caused by the light 306 while still allowing a comfortable and/or appropriate amount of the light 306 to pass through the panel 202 and into the vehicle cabin 114.

In some examples, to facilitate determining the second location 312 of the facial feature 314, a first one of the sensor(s) 106 (e.g., a camera) is directed at and/or facing the vehicle occupant 302. As shown in FIG. 3, the first one of the sensor(s) 106 is coupled to a portion of the vehicle 100 and positioned at least partially within the vehicle cabin 114. In such examples, the first one of the sensor(s) 106 generates and/or otherwise provides sensor data to the controller 102 that is indicative of the second location 312 of the facial feature 314. Although FIG. 3 depicts the first one of the sensor(s) 106 that is particularly configured, in some examples, the first one of the sensor(s) 106 is implemented differently (e.g., positioned on a different portion of the vehicle 100). Further, although FIG. 3 depicts a single sensor 106 directed at and/or facing the vehicle occupant 302, in some examples, the vehicle 100 is implemented with one or more other sensors in addition or alternatively to the first one of the sensor(s) 106 that is/are similarly configured to provide such sensor data to the controller 102.

FIG. 4 is an aerial view of the vehicle 100 and shows an example trajectory (e.g., a predetermined trajectory) 400 associated therewith, which is represented by the dotted/dashed line of FIG. 4. That is, the vehicle 100 is following and/or moving along at least a portion of the trajectory 400. Thus, the trajectory 400 of FIG. 4 represents one or more predicted locations of the vehicle 100. According to the illustrated example of FIG. 4, the trajectory 400 is associated with one or more example dazzling events 402, 404 during which the vehicle occupant(s) (e.g., the vehicle occupant 302) will likely be exposed, via the sunroof panel 202, to the light 306, two of which are shown in this example (i.e., a second dazzling event 402 and a third dazzling event 404). In some examples, the second dazzling event 402 and/or the third dazzling event 404 correspond to the first dazzling event 300.

The second dazzling event 402 of FIG. 4 includes a first example starting location (e.g., a predicted vehicle location) 406 and a first example ending location (e.g., a predicted vehicle location) 408, each of which corresponds to a portion of the trajectory 400. In some examples, the first starting and ending locations 406, 408 correspond to a first example road (e.g., a street, an avenue, a highway, a dirt road, etc.) 410, as shown in FIG. 4. The vehicle 100 of FIG. 4 is positioned on and/or moving along the first road 410. In particular, when the vehicle 100 is at or near the first starting location 406, the second dazzling event 402 begins and/or otherwise occurs. In other words, the vehicle occupant(s) is/are exposed to the light 306 via the sunroof panel 202 when the vehicle 100 is at or near the first starting location 406. Further, the first ending location 408 corresponds to a different portion of the trajectory 400 (e.g., a different portion of the first road 410). In some examples, when the vehicle 100 is at or near the first ending location 408, the first dazzling event 402 finishes and/or otherwise ceases occurring. In other words, the vehicle occupant(s) is/are no longer exposed to the light 306 and/or the primary portion 308 via the panel 202 when the vehicle 100 is at or near the first ending location 408. Although FIG. 4 depicts the first starting and ending locations 406, 408 of the first dazzling event 402 corresponding to the same road 410, in some examples, the first starting and ending locations 406, 408 corresponds to different respective roads.

The first starting and ending locations 406, 408 define a distance associated with the second dazzling event 402. That is, in some examples, the dazzling event occurs (e.g., continuously or uninterrupted) when the vehicle 100 is at portion of the trajectory 400 that is between the first starting and ending locations 406, 408. Thus, the second dazzling event 402 may occur for a time interval (e.g., a predetermined time interval such as 5 seconds, 30 seconds, 60 seconds, etc.) that is substantially based on one or more of a speed, an acceleration, a deceleration, etc. of the vehicle 100.

However, in some examples, the second dazzling event 402 may finish early and/or before the vehicle 100 reaches or is near the first ending location 408. For example, if the vehicle 100 substantially deviates from the trajectory 400, the vehicle occupant(s) is/are no longer exposed to the light 306 via the panel 202. In such examples, before the vehicle 100 reaches the first ending location 408, the vehicle 100 may perform a maneuver (e.g., an unexpected maneuver) and/or otherwise turn from the first road 410 onto a second example road 412 that is not associated with a dazzling event such that the vehicle 100 is no longer following the trajectory 400. That is, unlike the first road 410, a dazzling event will not likely occur when the vehicle 100 is driving on the second road 412. Additionally, in some examples, if an intensity of the light 306 during the second dazzling event 402 falls below a threshold intensity (e.g., a predetermined value of light intensity associated with user discomfort), the second dazzling event 402 finishes before the vehicle 100 reaches or is near the first ending location 408. For example, an example obstruction (e.g., a cloud, a building, etc.) may block (e.g., temporarily block) the light 306 when the vehicle 100 is moving between the first starting and end locations 406, 408. In such examples, the controller 102 accounts for such early completion of a dazzling event 300, 402, 404 and controls the panel 202 accordingly.

In some examples, to determine the vehicle trajectory 400, the controller 102 analyzes an example vehicle route (e.g., a predetermined route) 414 (represented by the dotted/dashed line of FIG. 4) associated with the vehicle 100, for example, generated by the vehicle system(s) 108. For example, the vehicle occupant 302 provides an example destination (e.g., a predicted vehicle location) 416 to the GPS and/or the navigation system of the vehicle 100 and, in response, the GPS and/or the navigation system generate the route 414 based on the destination 416 and the third observed location 316 of the vehicle 100. Thus, in the illustrated example of FIG. 4, the route 414 at least partially forms and/or defines the vehicle trajectory 400.

Additionally or alternatively, in some examples, the controller 102 analyzes one or more road parameters (e.g., a curvature or shape, a length, an inclination, etc.) of a road on which the vehicle 100 is positioned to determine the vehicle trajectory 400. For example, the controller 102 determines that the vehicle 100 is on a particular portion of the first road 410 based on the third observed location 316 of the vehicle 100. Then, the controller 102 determines, via the other data source(s) 110, one or more of a shape or curvature, a length, an inclination, etc. of the first road 410. Thus, according to the illustrated example of FIG. 4, a portion of the first road 410 in front of the vehicle 100 at least partially forms and/or defines the vehicle trajectory 400.

In some examples, similar to the second dazzling event 402, the third dazzling event 404 of FIG. 4 includes a second example starting location (e.g., a predicted vehicle location) 418 and a second example ending location (e.g., a predicted vehicle location) 420. The second starting and ending locations 418, 420 of FIG. 4 correspond to a different portion of the trajectory 400 compared to the first starting and ending locations 406, 408. In some examples, the second starting and ending locations 418, 420 correspond to a third example road (e.g., a street, an avenue, a highway, a dirt road, etc.) 422, as shown in FIG. 4. In particular, when the vehicle 100 is at or near the second starting location 418, the third dazzling event 404 begins and/or otherwise occurs. For example, after the vehicle 100 performs another example maneuver and/or otherwise turns from the first road 410 to the third road 422 at or near the second starting location 418, the third dazzling 404 event occurs. In such examples, the controller 102 predicts that the vehicle 100 will perform such maneuver based on the route 414 and, in response, adjusts dimming of the panel 202 in response to the vehicle 100 performing the maneuver.

Further, the second ending location 420 corresponds to a different portion of the trajectory 400 (e.g., a different portion of the third road 422). In particular, when the vehicle 100 is at or near the second ending location 420, the first dazzling event 402 finishes and/or otherwise ceases occurring. For example, as the vehicle 100 performs another example maneuver and/or otherwise turns from the third road 422 to a fourth example road 424 at or near the second ending location 420, the third dazzling 404 event occurs. As such, the fourth road 424 is not associated with a dazzling event. In such examples, the controller 102 predicts that the vehicle 100 will perform such a maneuver based on the route 414 and, in response, ceases adjusting dimming of the panel 202 in response to the vehicle 100 performing the maneuver.

As shown in FIG. 4, the first road 410 is substantially curved and, thus, at least a portion of the trajectory 400 is curved, which indicates to the controller 102 that a dazzling event is likely to occur and/or cease occurring while the vehicle 100 is moving the first road 410. On the other hand, the third road 422 is substantially straight and, thus, at least a portion of the trajectory 400 is also substantially straight, which indicates to the controller 102 that the third dazzling event 404 is not likely to cease occurring until the vehicle 100 substantially deviates from the trajectory 400 and/or the route 414. Thus, in some examples, the controller 102 accounts for such road parameters when determining when and/or how to control the sunroof panel 202.

As shown in FIG. 4, the third observed location 316 of the vehicle 100 and the first starting location 406 define an example distance of interest (e.g., 10 feet, 100 feet, 1,000, feet, etc.) 426. In some examples, the controller 102 calculates the distance of interest 426 based on one or more of the third observed location 316, the first starting location 406, and/or the curvature or shape of the first road 410. In some such examples, this distance of interest 426 serves as a trigger for the controller 102 to carry out dimming adjustment(s) associated with the panel 202 to protect the vehicle occupant 302 during the second dazzling event 402. For example, the controller 102 may repeatedly and/or continuously calculate the distance of interest 426 and compare the distance of interest 426 to a threshold distance, as discussed further below. In particular, when the controller 102 determines that the distance of interest 426 is less than or below the threshold distance (i.e., the second dazzling event 402 is about to begin and/or otherwise occur), the controller 102 adjusts dimming of the panel 202.

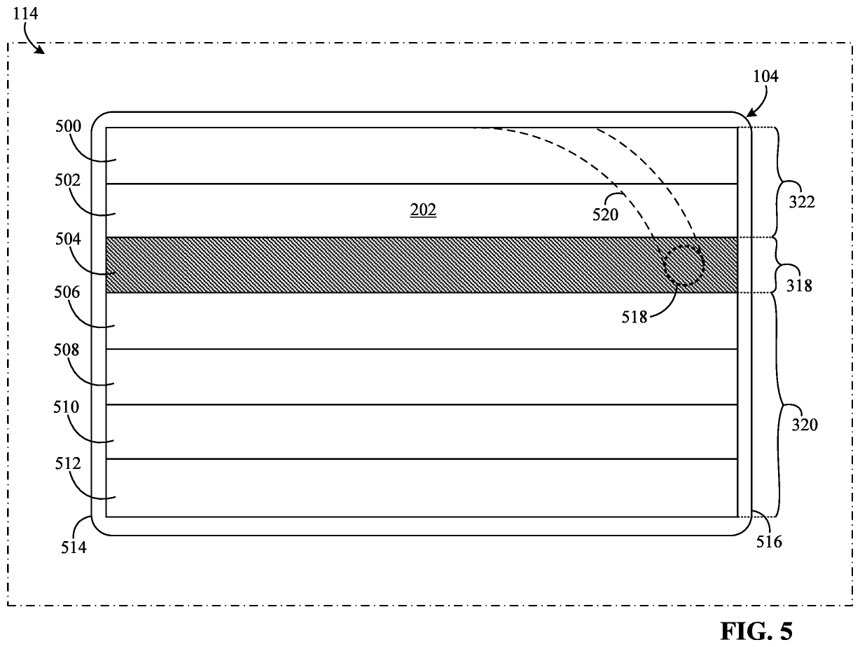

FIG. 5 is a bottom-view of the vehicle sunroof 104 within the vehicle cabin 114 and shows the dimmable panel 202. According to the illustrated example of FIG. 5, the panel 202 includes example dimming bands 500, 502, 504, 506, 508, 510, 512 positioned thereon, seven of which are shown in this example. In other words, the panel 202 of FIG. 5 includes a first dimming band 500, a second dimming band 502, a third dimming band 504, a fourth dimming band 506, a fifth dimming band 508, a sixth dimming band 510, and a seventh dimming band 512. In particular, each of the dimming bands 500, 502, 504, 506, 508, 510, 512 has a visual characteristic (e.g., one or more of a transparency, a tint, a color, etc.) associated therewith that changes, for example, based on an electrical parameter (e.g., a voltage, a current, etc.) provided to the respective one of the bands 500, 502, 504, 506, 508, 510, 512. For example, as a voltage applied to a particular band 500, 502, 504, 506, 508, 510, 512 increases, a transparency of that band 500, 502, 504, 506, 508, 510, 512 increases (i.e., a degree of dimming or tint associated therewith decreases). Conversely, as the voltage applied to the band 500, 502, 504, 506, 508, 510, 512 decreases, the transparency of the band 500, 502, 504, 506, 508, 510, 512 decreases (i.e., the degree of dimming or tint associated therewith increases). Although FIG. 5 depicts the sunroof panel 202 having the seven dimming bands 500, 502, 504, 506, 508, 510, 512, in some examples, the sunroof panel 202 includes additional or fewer dimming bands.

As shown in FIG. 5, the third band 504 (i.e., the primary area 318) is less transparent and/or otherwise dim relative to the other bands 500, 502, 506, 508, 510, 512 (i.e., the secondary area(s) 320, 322), which provides the second state of the sunroof panel 202. However, in some examples, when the sunroof panel 202 is in the second state, one or more (e.g., all) of the other bands 500, 502, 506, 508, 510, 512 are dim in addition or alternatively to the third band 504.

As shown in FIG. 5, each of the dimming bands 500, 502, 504, 506, 508, 510, 512 extends from a first side 514 of the sunroof panel 202 to a second side 516 of the sunroof panel 202 opposite the first side 514. In some such examples, each of the dimming bands 500, 502, 504, 506, 508, 510, 512 is rectangular. Although FIG. 5 depicts the sunroof panel 202 having the rectangular dimming bands 500, 502, 504, 506, 508, 510, 512 that extend across a width of the sunroof panel 202, in some examples, the sunroof panel 202 is implemented differently while maintaining similar dimming functionality. For example, one or more (e.g., all) of the bands 500, 502, 504, 506, 508, 510, 512 may be shaped differently. Further, in some examples, instead of the dimming bands 500, 502, 504, 506, 508, 510, 512, the sunroof panel 202 may define a grid of relatively small square areas, each of which is dimmable.

According to the illustrated example, the controller 102 determines a predicted location 518 of the light source 304 relative to the vehicle 100. That is, the light source 304 will appear to be in the predicted location 518 during a dazzling event such as, for example, the second dazzling event 402. Accordingly, in such examples, when the vehicle 100 reaches one of the first starting location 406, the first ending location 408, or a location defined by the trajectory 400 that is between the first starting location 406 and the first ending location 408, the light source 304 will appear to be in the predicted location 518.

In some examples, the external light source 202 follows an apparent path 518 relative to the vehicle 100 based on movement (e.g., rotation or yaw) of the vehicle 100 relative to the light source 302 before reaching the predicted location 518, as represented by the dotted/dashed line of FIG. 5. As a result, in such examples, the controller 102 adjusts dimming of at least some of the dimming bands 500, 502, 504, 506, 508, 510, 512 to account for such movement of the vehicle 100 relative to the light source 302. For example, when the glare corresponds to and/or is associated with the first band 500, the controller 102 causes the first band 500 to change from a first state to a second state in which the first band 500 is less transparent relative to the first state. Then, when the glare corresponds to and/or is associated with the second band 502 instead of the first band 500, the controller 102 causes the first band 500 to change from the second state back to the first state and also causes the second band 502 to change from a first state to a second state in which the second band 502 is less transparent relative to the first state. Then, when the glare corresponds to and/or is associated with the third band 504 instead of the second band 502, the controller 102 causes the second band 502 to change from the second state back to the first state and also causes the third band 504 to change from a first state to a second state in which the third band 504 is less transparent relative to the first state.

Alternatively, in some examples, the controller 102 dims and/or otherwise increase a degree of dimming each of the bands 500, 502, 504, 506, 508, 510, 512 (i.e., the entire panel 202) before the vehicle occupant 302 encounters any glare until the light source 304 reaches the predicted position 518. Then, in such examples, when the light source 304 reaches the predicted location 518, the controller 102 reduces the degree of dimming of each of the first, second, fourth, fifth, six, and seventh bands 500, 502, 506, 508, 510, 512 while leaving the third band 504 substantially dim.

In some examples, the dimming bands 500, 502, 504, 506, 508, 510, 512 form and/or define the primary area 318 and the secondary area(s) 320, 322 of the panel 202. According to the illustrated example of FIG. 5, the third dimming band 504 forms and/or defines the primary area 318 of the panel 202. As such, in this example, the first, second, fourth, fifth, sixth, and seventh dimming bands 500, 502, 506, 508, 510, 512 form and/or define the secondary area(s) 320, 322. That is, the controller 102 is controlling, via the third band 504, the sunroof panel 202 such that the primary area 318 is less transparent relative to the secondary area(s) 320, 322, which reduces the brightness of the primary portion 308 of the light 306 viewed and/or encountered by the vehicle occupant 302 during the associated dazzling event. As such, the primary area 318 of the panel 202 absorbs and/or reflects the primary portion 308 and/or otherwise reduces an intensity of the primary portion 308 that will enter the vehicle cabin 114. For example, the primary area 308 reduces the intensity of the primary light portion 308 within the cabin 114 by about 90%. Further, in such examples, the secondary area(s) 320, 322 do not substantially reduce an intensity of the secondary portion 309 of the light 306 that enter the vehicle cabin 114.

Although FIG. 5 depicts the panel 202 having the primary area 318 that is less transparent relative to the secondary area(s) 320, 322, in some examples, the controller 102 controls the panel 202 differently. For example, the controller 102 may reduce transparency of the entire panel 202 (i.e., the primary area 318 and the secondary areas 320, 322).

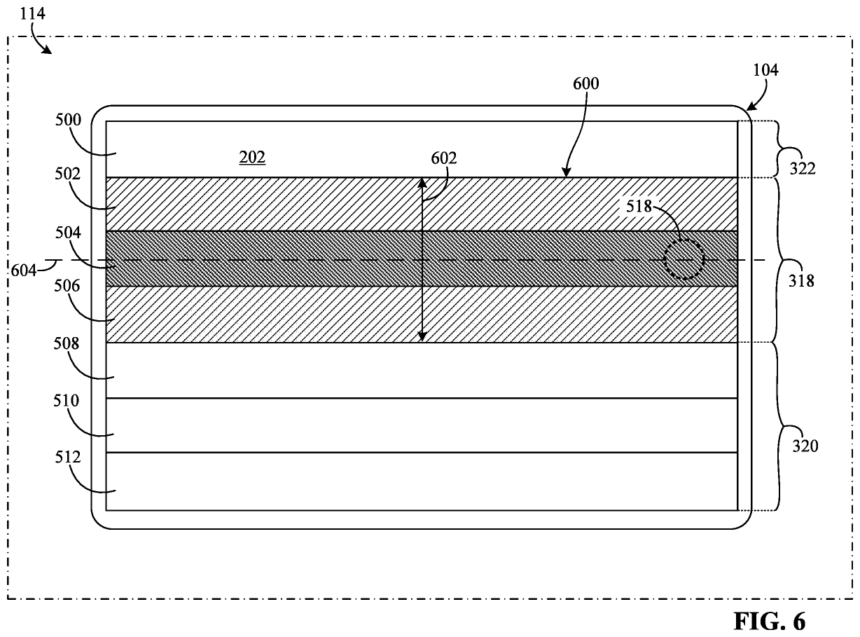

FIG. 6 is another bottom-view of the vehicle sunroof 104 within the vehicle cabin 114 and shows the dimmable panel 202. According to the illustrated example of FIG. 6, the controller 102 is controlling, via at least some of the band(s) 500, 502, 504, 506, 508, 510, 512, the sunroof panel 202 to generate an example gradient 600 thereon, which is sometimes referred to as a dimming gradient. As such, the sunroof 202 of FIG. 6 is in the second state. In such examples, the transparency of the panel 202 varies across at least portion (e.g., one or more of a length, a width, etc.) 602 of the dimming gradient 600. In some examples, the transparency of the panel 202 decreases relative to an example axis (e.g., a horizontal axis) 604 and/or a particular band (e.g., the third band 504) corresponding to and/or associated with the glare that will be encountered by the vehicle occupant 302 during a predicted dazzling event. For example, the third band 504 of FIG. 6 is less transparent relative to the second band 502 and the fourth band 506 (i.e., relative to adjacent ones of the bands). Further, the second band 502 and the fourth band 506 are less transparent relative to the first, fifth, sixth and seventh bands 500, 508, 510, 512. Further, in some examples, the dimming gradient 600 is formed by all of the bands 500, 502, 504, 506, 508, 510, 512. As a result, the dimming gradient 600 reduces a surrounding glare that may be encountered by the vehicle occupant 302 during a predicted dazzling event.

In some examples, the dimming gradient 600 corresponds to the primary area 318, as shown in FIG. 6. However, in some examples, the dimming gradient 600 corresponds to primary area 318 and the secondary area(s) 320, 322 (i.e., the entire panel 202).

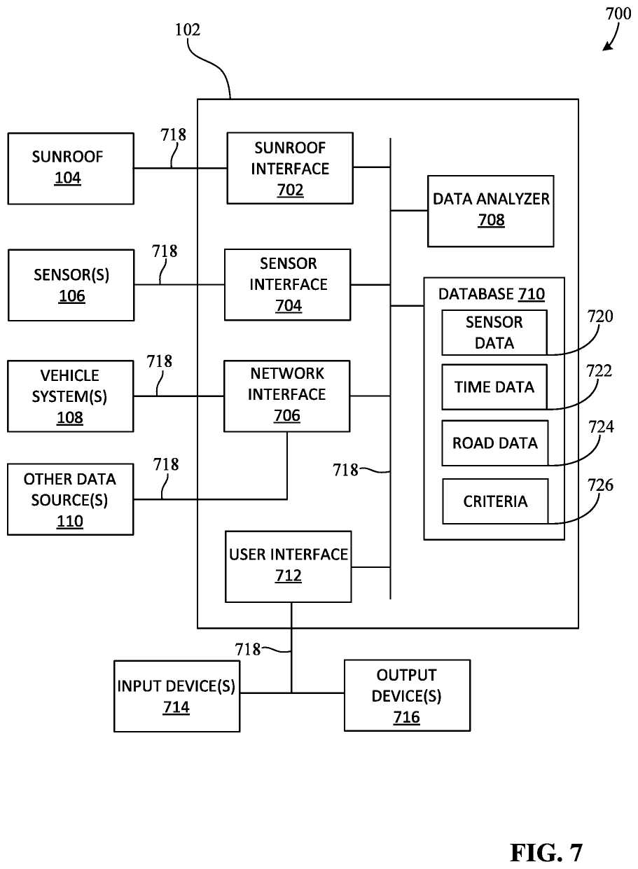

FIG. 7 is a block diagram of an example sunroof dimming system 700 to implement the examples disclosed herein. According to the illustrated example of FIG. 7, the sunroof dimming system 700 includes the sunroof controller 102, which includes an example sunroof interface 702, an example sensor interface 704, an example network interface 706, an example data analyzer 708, an example database 710, and an example user interface 712. In some examples, the sunroof dimming system 700 of FIG. 7 also includes one or more of the vehicle sunroof 104, the sensor(s) 106, the vehicle system(s) 108, the other data source(s) 110, one or more example input devices 714, and one or more example output devices 716, as shown in FIG. 7. To provide and/or facilitate communications between such components or elements, the sunroof dimming system of FIG. 7 also includes one or more example communication links 718 such as, for example, signal or transmission wire(s), a bus (e.g., a CAN), radio frequency, etc. In particular, the sunroof dimming system 700 of FIG. 7 detects, via processing example data (e.g., stored in the database 710), a condition (e.g., the first condition) associated with the vehicle 100 and, in response, directs the sunroof 104 to adjust dimming of the panel 202. This data includes data associated with operation of the vehicle 100 such as, for example, one or more of example sensor data 720, example time data 722, and example road data 724. Additionally, in some examples, this data also includes example criteria 728, which enables the data analyzer 708 to predict and/to determine whether a dazzling event 300, 402, 404 will occur when compared to and/or otherwise processed with at least some of the other data 720, 722, 724.

The sunroof interface 702 of FIG. 7 is connected, via the link(s) 718, to the dimmable panel 202 to direct and/or control the visual characteristic(s) of the panel 202. In some examples, the sunroof interface 702 is connected to each of the dimming bands 500, 502, 504, 506, 508, 510, 512 such that the sunroof interface 702 can independently control each band 500, 502, 504, 506, 508, 510, 512. In particular, the sunroof interface 702 adjusts (e.g., increases or decreases) and/or otherwise controls the electrical parameter(s) provided to one or more of the dimming bands 500, 502, 504, 506, 508, 510, 512 and/or, more generally, the panel 202. For example, the sunroof interface 702 receives one or more adjustments that are determined by the data analyzer 708 and, in response, applies the adjustment(s) to the panel 202 and/or otherwise carries out the adjustment(s).

In some examples, as the sunroof interface 702 decreases a voltage applied to the panel 202 (e.g., before one of the dazzling events 300, 402, 404 begins), a degree of dimming of the panel 202 increases and/or the panel 202 becomes less transparent. That is, the sunroof interface 702 causes the panel 202 to change from the first state to the second state. As a result, when the light 306 is directed through the panel 202 and onto the vehicle occupant 302 (e.g., during one of the dazzling events 300, 402, 404), the brightness and/or the intensity of the light 306 encountered by the vehicle occupant 302 is reduced, mitigated, and/or eliminated. Conversely, as the sunroof interface 702 increases the voltage applied to the panel 202 (e.g., after one of the dazzling events 300, 402, 404), the degree of dimming of the panel 202 decreases and/or the panel 202 becomes more transparent. That is, the panel 202 changes from the second state to the first state. Additionally, in some examples, the sunroof interface 702 similarly adjusts voltage provided to one or more of the dimming bands 500, 502, 504, 506, 508, 510, 512 in this manner.

The sensor interface 704 of FIG. 7 is connected, via the link(s) 718, to the sensor(s) 106 to receive at least some of the sensor data 720 therefrom. As such, the sensor data 712 of FIG. 7 includes one or more of: (1) image data; (2) vehicle positional data (e.g., GPS data); (3) vehicle orientation data; (4) light intensity data; (5) vehicle acceleration data; (6) vehicle deceleration data; and/or (7) rotational wheel parameter data. In particular, the sensor data 712 indicates to the data analyzer 708 one or more of the first observed location 310, the second observed location 312, the third observed location 316, the trajectory 400, a speed of the vehicle 100, and/or one or more locations defined by the trajectory 400.

The network interface 706 of FIG. 7 is connected, via the link(s) 718, to the vehicle system(s) 108 to receive at least some of the data 720, 722, 724, 726 therefrom. In some examples, the network interface 706 receives at least some of the time data 722 from the other data source(s) 110. For example, the time data 722 corresponds to a time of day (e.g., 10:00 AM, 12:00 PM, 2:00 PM). In examples where the light source 302 is the sun, the time of day enables the data analyzer 708 to determine the first observed location 310 of the light source 302. In some examples, the network interface 706 receives at least some of the road data 724 from the other data source(s) 110 that corresponds to one or more parameters of road(s) (e.g., one or more of the first road 410, the second road 412, the third road 422, etc.) such as, for example, a road length, a road shape or curvature, a road incline, a road type, etc. In some examples, the network interface 706 receives at least some of the sensor data 720 (e.g., the vehicle positional data) from the vehicle system(s) 108 such as, for example, the GPS system and/or the navigation system of the vehicle 100. Further, in some examples, the network interface 706 receives at least some of the sensor data 720 (e.g., the image data). Further, in some examples, the network interface 706 receives at least some of the criteria 726, for example, via one or more software updates provided by a vehicle manufacturer and/or a vehicle part supplier. However, in some examples, at least some of the criteria 726 are preprogrammed into the database 710.

The user interface 712 of FIG. 7 is connected, via the link(s) 718, to the input device(s) 714 to receive user data and/or inputs therefrom. In some examples, the user interface 712 receives user data from the input device(s) 714 corresponding to the destination 416, which enables the vehicle system(s) 108 (e.g., the GPS and/or the navigation system) to determine and/or otherwise generate the predetermined route 414 associated with the vehicle 100. In such examples, the predetermined route 414 is then provided (e.g., via the network interface 706 and/or the link(s) 718) to the output device(s) 716 for viewing by the vehicle occupant 302 in addition to the data analyzer 708 for further processing.

In some examples, the user interface 704 receives user data from the input device(s) 714 corresponding to a manual dimming adjustment for the panel 202, for example, if the vehicle occupant 302 desires to slightly reduce sunlight passing through the panel 202 and into the vehicle cabin 114. In such examples, the sunroof interface 704 causes the panel 202 (e.g., all of the bands 500, 502, 504, 506, 508, 510) to become slightly less transparent in the first state thereof, for example, to reduce sunlight intensity by about 10% and about 20%.

The input device(s) 714 of FIG. 7 include one or more of a button, a switch, a touchscreen, a microphone, etc. that the vehicle occupant 302 can interact with to provide the above mentioned input(s) and/or selection(s). For example, in response to the vehicle occupant 302 (and/or a different vehicle occupant) interacting with the input device(s) 714, the input device(s) 714 provide (e.g., via the link(s) 718) corresponding input(s) and/or selection(s) to the user interface 712.

In some examples, the user interface 712 is also connected, via the link(s) 718, to the output device(s) 714 to control output thereof. In particular, the user interface 704 provides control signal(s) or command(s) and/or power to the output device(s) 714, thereby generating one or more images (e.g., a map associated with navigating the vehicle 100) for viewing by the user corresponding to the predetermined route 414 and/or one or more sounds (e.g., speech or voice commands) corresponding to the predetermined route 414. That is, in some examples, the user interface 704 generates, via the output device(s) 714; the predetermined route 414 to better enable a vehicle occupant 302 to maneuver the vehicle 100 in accordance with the predetermined route 414.

The database 710 of FIG. 7 stores and/or provides access to at least a portion of the data 720, 722, 724, 726 and/or any other appropriate data associated with the vehicle 100 and/or the sunroof dimming system 700. In particular, the database 710 is connected, via the link(s) 718, to one or more of the sunroof interface 702, the sensor interface 704, the network interface 706, the data analyzer 708, and/or the user interface 712 to transmit the data 720, 722, 724, 726. For example, the database 710 receives data from one or more of the sunroof interface 702, the sensor interface 704, the network interface 706, the data analyzer 708, and/or the user interface 712. Conversely, the database 710 provides data to one or more of the sunroof interface 702, the sensor interface 704, the network interface 706, the data analyzer 708, and/or the user interface 712. In some examples, the database 710 stores the criteria 726, which may be preprogrammed into the database 710 and/or provided thereto via the network interface 706, as previously mentioned.

The data analyzer 708 of FIG. 7 detects, determines, and/or identifies one or more example sets of data associated with operation of the vehicle 100 to compare to the criteria 726, which indicates to the data analyzer 708 whether a dazzling event (e.g., one of the first dazzling event 300, the second dazzling event 402, or the third dazzling event 404) is likely to begin and/or otherwise occur while the vehicle 100 is moving. For example, an example set of data includes the first observed location 310 of the light source 304, the second observed location 312 of the facial feature 314, a first predicted location of the vehicle 100, and a first predicted orientation of the vehicle 100 corresponding to the first predicted location. In particular, if the first observed location 310, the second observed location 312, the first predicted location, and the first predicted orientation satisfy the criteria 726, the data analyzer 708 determines that the dazzling event will likely occur.

In examples where the light source 304 is the sun, the first observed location 310 corresponds to the time of day. Accordingly, in such examples, the data analyzer 708 detects the first location 310 based on such time data 722. Additionally or alternatively, in some examples, the data analyzer 708 determines the first observed location 310 via the sensor(s) 106 (e.g., a camera) that is positioned at and/or facing the light source 304. The first observed location 310 may include positional data stored in the database 720 such as, for example, one or more example coordinates (e.g., one or more of a first x-coordinate X₁, a first y-coordinate Y₁, and/or a first z-coordinate Z₁).

Further, in some examples, the data analyzer 708 detects, via the sensor(s) 106 (e.g., the camera) and/or the vehicle system(s) 108 (e.g., the camera monitoring system), the second observed location 312 of the facial feature 314. The second location 312 may similarly include positional data stored in the database 710 such as, for example, one or more example coordinates (e.g., one or more of a second x-coordinate X₂, a second y-coordinate Y₂, and/or a second z-coordinate Z₂).

Further, in some examples, the data analyzer 708 detects the third observed location 316 of the vehicle 100 via the sensor(s) 106 (e.g., the GPS locator). Similarly, in some examples, the data analyzer 708 detects the third observed location 316 via the vehicle system(s) 108 (e.g., the GPS and/or the navigation system). The third location 316 may also include one or more example coordinates (e.g., one or more of a third x-coordinate X₃, a third y-coordinate Y₃, and/or a third z-coordinate Z₃).

In some examples, to facilitate determining one or more predicted locations and/or predicted orientations of the vehicle 100, the data analyzer 708 calculates one or more trajectories of the vehicle 100. For example, the data analyzer 708 calculates the trajectory 400 of FIG. 4, for example, based on the predetermined route 412. Additionally or alternatively, the data analyzer 708 calculates the trajectory 400 based on one or more parameters of the first road 410 on which the vehicle 100 moving such as, for example, a curvature or shape, a length, an inclination, etc. In particular, the data analyzer 708 then analyzes one or more (e.g., all) portions of such a vehicle trajectory.

Further, the data analyzer 708 of FIG. 0.7 particularly processes the data 720, 722, 724, 726 to detect a condition (e.g., a predicted condition) of the vehicle 100 (e.g., the first condition of FIG. 3). In particular, the criteria 726 include predetermined sets of example data indicative of a dazzling event (e.g., one of the first dazzling event 300, the second dazzling event 402, the third dazzling event 404, etc.). For example, a set of such data includes a light source location (e.g., the first observed location 310 of the light source 304), a facial feature location (e.g., the second observed location 312 of the facial feature 314), a vehicle location (e.g., one of the locations 406, 408, 416, 418, 420) and a vehicle orientation corresponding to the vehicle location. Thus, the criteria 726 include many sets of such predetermined data.

In some examples, the data analyzer 308 determines one or more adjustments for the sunroof panel 202 associated with dimming at least a portion the sunroof panel 202 (e.g., dimming one or more of the hands 500, 502, 504, 506, 508, 510, 512). For example, a disclosed adjustment includes an increase in the voltage provided to one or more portions of the panel 202. In particular, the data analyzer 308 provides the adjustment(s) to the sunroof interface 702 to be carried out at an appropriate time.

As such, in some examples, the data analyzer 708 also determines whether to wait to provide the adjustment(s) to the sunroof interface 702 and/or otherwise carry out the adjustment(s). For example, the data analyzer 708 determines to wait if the vehicle 100 is substantially far away from the first starting location 406. In such examples, the data analyzer 708 first calculates the distance of interest 426, for example, based on one or more of the third observed location 316, the first starting location 406, and/or the curvature or shape of the first road 410. Then, the data analyzer 708 compares the distance of interest 426 to a threshold distance (e.g., a value corresponding to a particular distance such as 100 feet, 50 feet, 25 feet etc.). If the comparison indicates that the distance of interest 426 is less than or below the threshold distance, the sunroof system 700 determines to wait. Further, in some examples, the data analyzer 708 calculates a time interval within which the vehicle 100 will reach the first starting location 406 for example, based on the distance of interest 426 and a speed of the vehicle 100.

Additionally, in some examples, the data analyzer 708 determines that, during the second dazzling event 402, the third band 504 (i.e., an area of the sunroof panel 202) will be aligned to the facial feature 314 and the light source 306 when the vehicle 100 reaches or is near the first starting location 406. The data analyzer 708 makes such a determination based on at least a portion of the data 720, 722, 724, 726.

Although an example sunroof dimming system 700 is illustrated in FIG. 7, one or more of the elements, processes, and/or devices depicted in FIG. 7 may be combined, divided, re-arranged, omitted, eliminated, and/or implemented in any other way. Further, the example sunroof dimming system 700 of FIG. 7 may include one or more elements, processes, and/or devices in addition or alternatively to those illustrated in FIG. 7, and/or may include more than one of any or all of the illustrated elements, processes, and devices.

Additionally, one or more of the example elements 102, 702, 704, 705, 706, 708, 710, 712 and/or the example sunroof dimming system 700 of FIG. 7 may be implemented by hardware, software, firmware and/or any combination of thereof. For example, any of the example element(s) 102, 702, 704, 705, 706, 708, 710, 712 and/or, more generally, the example sunroof dimming system 700 could be implemented by one or more circuits (e.g., an analog or digital circuit, a logic circuit, a programmable processor, etc.). Further, in some examples, at least one of the example element(s) 102, 702, 704, 705, 706, 708, 710, 712 and/or, more generally, the example sunroof dimming system 700 include(s) a tangible machine-readable storage device or storage disk (e.g., a memory storing the software and/or firmware).

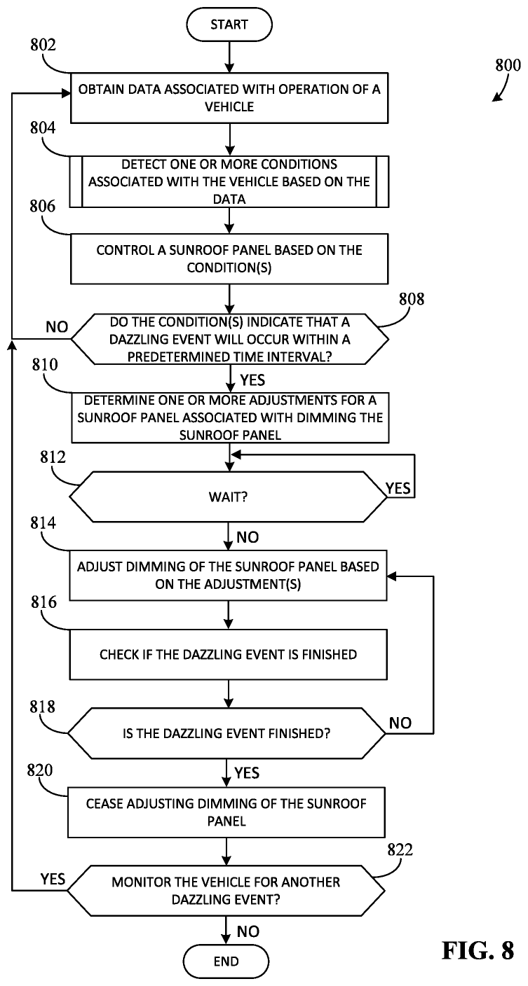

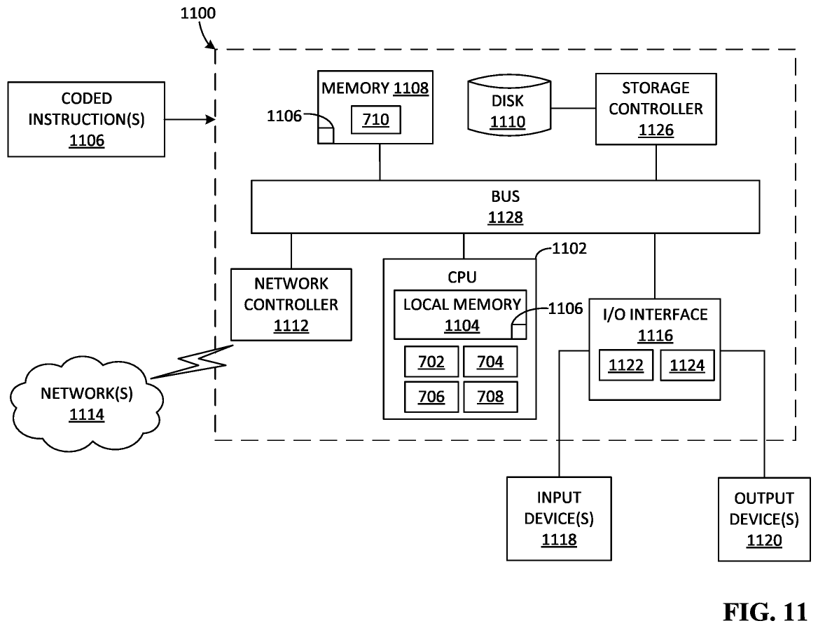

Flow diagrams representative of example hardware logic or machine-readable instructions for implementing the example sunroof dimming system 700 of FIG. 7 are shown in FIGS. 8-10. The machine-readable instructions may be a program or portion of a program for execution by a processor (e.g., the CPU 1102 of FIG. 11), which is discussed further below in connection with FIG. 11. The program may be embodied in software stored on a tangible machine-readable storage medium such as a CD-ROM, a floppy disk, a hard drive, or a memory associated with the processor. Alternatively, the entire program and/or parts thereof could be executed by a different device and/or embodied in firmware or dedicated hardware.

The example processes of FIGS. 8-10 may be implemented using executable or coded instructions (e.g. computer or machine readable instructions) stored on a tangible machine-readable storage medium such as a hard disk drive, a compact disk (CD), a flash memory, and/or other storage device or disk in which information is stored for any duration of time. As used herein, the term tangible machine-readable storage medium is expressly defined to include any type of computer or machine-readable storage device or disk and to exclude propagating signals and all transmission media. Additionally or alternatively, the example methods of FIGS. 8-10 may be implemented using coded instructions stored on a, non-transitory machine-readable medium in which information is stored for any duration, which includes any type of computer or machine readable storage device or disk and excludes propagating signals and transmission media.

FIG. 8 is a flow diagram representative of an example method 800 that can be executed to implement the sunroof dimming system 700 of FIG. 7 to adjust dimming of a sunroof panel. The example method 800 of FIG. 8 can be implemented in any of the vehicle 100 of FIGS. 1-4, the controller 102 of FIGS. 1 and 7, and/or the sunroof dimming system 700 of FIG. 7.

The method 800 of FIG. 8 begins by obtaining data associated with operation of a vehicle (block 802). In some examples, the example sunroof dimming system 700 of FIG. 7 obtains and/or otherwise receives at least some of the data 720, 722, 724, 726, which is associated with operation of the vehicle 100. For example, the sunroof dimming system 700 obtains (e.g., via the sensor interface 702 and/or the network interface 706) at least some of the sensor data 720 from the sensor(s) 106 and/or the vehicle system(s) 108. In another example, the sunroof dimming system 700 obtains (e.g., via the sensor interface 702 and/or the network interface 706) at least some of the time data 722 from one or more of the sensor(s) 106, the vehicle system(s) 108, and/or the other data source(s) 110. In yet another example, the sunroof dimming system 700 obtains (e.g., via the network interface 706) at least some of the road data. 724 from the vehicle system(s) 108 and/or the other data source(s) 110. In yet another example, the sunroof dimming system 700 obtains (e.g., via the network interface 706) the destination 416 and/or the predetermined vehicle route 414 from the vehicle system(s) 108.

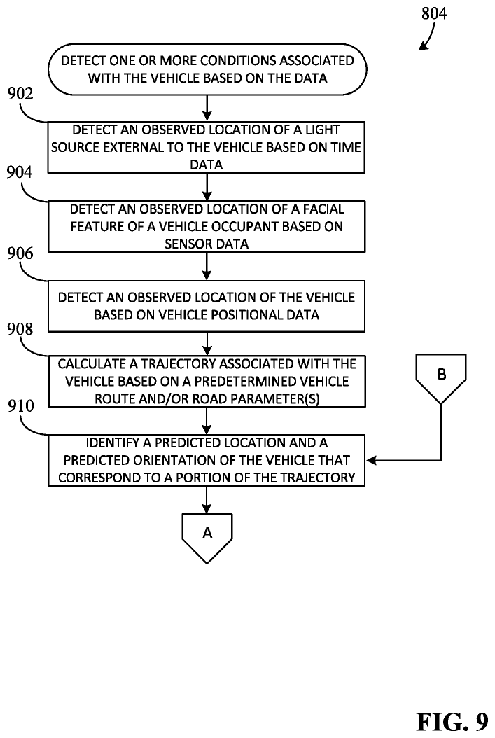

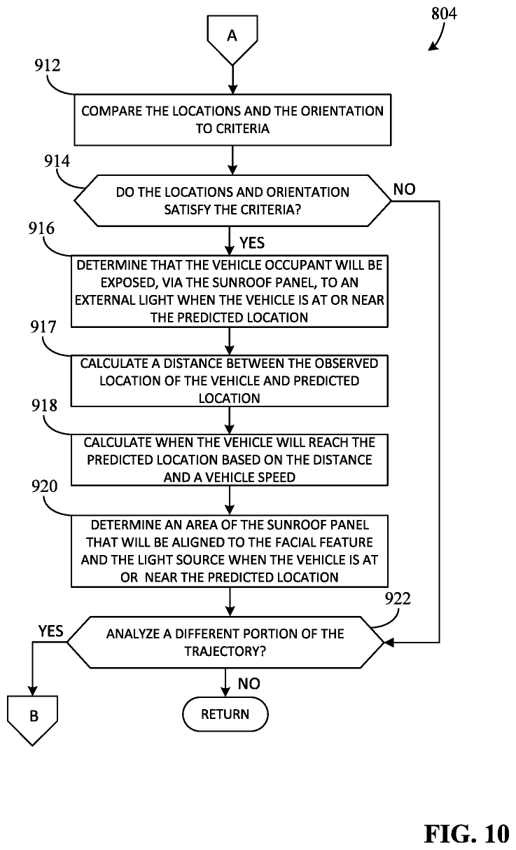

The method 800 of FIG. 8 also includes detecting one or more conditions associated with the vehicle based on the data (block 804). In some examples, the sunroof dimming system 700 of FIG. 7 detects (e.g., via the data analyzer 708) a condition of the vehicle 100 based on at least some of the data 720, 727, 724, 726. In particular, the sunroof dimming system 700 detects that the first condition of the vehicle 100 (e.g., see FIG. 3) will occur within a predetermined time interval, as discussed further below in connection with FIGS. 9 and 10. That is, the sunroof dimming system 700 detects that the vehicle occupant 302 will likely be exposed, via the panel 202, to at least a portion of the external light 306 while the vehicle 100 is moving, which is indicative of a dazzling event (e.g., the second dazzling event 402).

Additionally or alternatively, in some examples, the sunroof dimming system 700 detects, via the sensor(s) 106 a light intensity that is inside the vehicle cabin 114 and/or external to the vehicle 100. Additionally, in some examples, the sunroof dimming system 700 detects that a user provided input to the input device(s) 714 to manually dim the panel 202.

The method 800 of FIG. 8 also includes controlling a sunroof panel based on the condition(s) (block 806). In some examples, the sunroof dimming system 700 of FIG. 7 controls (e.g., via the sunroof interface 702) the sunroof panel 202 based on the condition(s) of the vehicle 100 detected in connection with block 804. For example; the sunroof dimming system 700 controls the panel 202 to provide the first state thereof, for example, based on the light intensity detected in connection with block 804. In some examples, the sunroof dimming system 700 controls the panel 202 to provide the first state thereof based on the user input detected in connection with block 804, for example, if the vehicle occupant 302 desires the panel 202 at least slightly dim.

The method 800 of FIG. 8 also includes determining whether the condition(s) indicates that a dazzling event will occur within a predetermined time interval (block 808). In some examples, the sunroof dimming system 700 of FIG. 7 determines (e.g., via the data analyzer 708) whether one or more of the first, second, and/or third dazzling events 300, 402, 404 will occur within a predetermined time interval based on the condition(s) of the vehicle 100 detected in connection with block 804. For example, the sunroof dimming system 700 determines the second dazzling event 402 will occur (i.e.; provides a positive determination). In such examples, if the sunroof dimming system 700 provides a positive determination (block 808: YES), control of the method 800 proceeds to block 810. On the other hand, in some examples, if the sunroof dimming system 700 provides a negative determination (block 808: NO), control of the method 800 returns to block 802.

The method 800 of FIG. 8 also includes determining one or more adjustments for a sunroof panel associated with dimming the sunroof panel (block 810). In some examples, the sunroof dimming system 700 of FIG. 7 determines (e.g., via the data analyzer 308) one or more adjustments for the sunroof panel 202 associated with changing the visual characteristic(s) associated with and/or otherwise dimming one or more portions the sunroof panel 202 (e.g., dimming one or more of the bands 500, 502, 504, 506, 508, 510, 512). In some examples, the adjustment includes a change (e.g., a decrease) in the electrical parameter(s) (e.g., one or more of voltage, current, etc.) provided to the portion(s) of the panel 202.

The method 800 of FIG. 8 also includes determining whether to wait (block 812). In some examples, the sunroof dimming system 700 of FIG. 7 determines (e.g., via the data analyzer 708) whether to wait to adjust dimming of the sunroof panel 202. For example, the sunroof dimming system 700 waits if the vehicle 100 is substantially far away from the first starting location 406. For example, the sunroof dimming system 700 compares (e.g., via the data analyzer 708) the distance 426 of interest defined between the third observed location 316 and the first starting location 406 to the threshold distance. If the comparison indicates that the distance of interest 426 is above or greater than the threshold distance, the sunroof system 700 determines to wait. However, if the comparison indicates that the distance of interest 426 is below or less than the threshold distance, the sunroof system 700 determines not to wait.

In some examples, if the sunroof dimming system 700 provides a positive determination (block 812: YES), the sunroof system 700 waits and/or control of the method 800 returns to block 812. On the other hand, if the sunroof dimming system 700 provides a negative determination (block 812: NO), control of the method 800 proceeds to block 814.

The method 800 of FIG. 8 also includes adjusting dimming of the sunroof panel based on the adjustment(s) (block 814). In some examples, the sunroof dimming system 700 of FIG. 7 adjusts (e.g., via the sunroof interface702) dimming of the sunroof panel 202 based on the adjustment(s) determined in connection with block 810, thereby changing the panel 202 from the first state to the second state. In this manner, the sunroof dimming system 700 reduces a brightness and/or an intensity of the light 306 that the vehicle occupant 302 will encounter through the panel 202 during the detected dazzling event 402 and/or when the vehicle 100 is at or near the starting location 406 associated therewith. In particular, the sunroof dimming system 700 carries out the adjustment(s) before the detected dazzling event 402 begins and/or before vehicle 100 is at or near the associated starting location 406 to prevent the vehicle occupant 302 from being dazzled by the light 306.

In some examples, when the adjustment(s) is/are carried out, the sunroof dimming system 700 controls the panel 202 to dim the primary area 318 and/or otherwise cause the primary area 318 to become less transparent relative to the secondary area(s) 320, 322 (e.g., see FIG. 5 and/or FIG. 6). In this manner, the sunroof dimming system 700 allows the secondary portion 309 of the light 306 to pass into the cabin 114 while still preventing the vehicle occupant 302 from being dazzled by the primary portion 308 of the light 306. That is, in such examples, the primary area 318 allows less light to pass therethrough into the vehicle cabin 114 relative to the secondary area(s) 320, 322. As a result, the sunroof dimming system 700 reduces, mitigates, and/or eliminates a glare that would have otherwise been encountered by the vehicle occupant 302 through the primary area 318 during the detected dazzling event 402.

Additionally or alternatively, in some examples, when the adjustment(s) is/acre carried out, the sunroof dimming system 700 controls the panel 202 to generate the dimming gradient 600. In some such examples, the dimming gradient 600 corresponds to the entire panel 202 or only the primary area 318 (e.g., see FIG. 6). Further, in some examples, the sunroof dimming system 700 generates the dimming gradient 600 via the bands 500, 502, 504, 506, 508, 510, 512. Further, in some examples, when the adjustment(s) is/are carried out; the sunroof dimming system 700 controls the panel 202 to cause the primary area 318 to shift and/or move based on movement of the vehicle 100 relative to the light source 304, for example, to account for the apparent path 520 of the light 304 relative to the vehicle 100 resulting from vehicle yaw or rotation.

The method 800 of FIG. 8 also includes checking whether the dazzling event is finished (block 816). In some examples, the sunroof dimming system 700 of FIG. 7 checks (e.g., via the data analyzer 708) whether the detected dazzling event 402 is finished. As previously mentioned, the detected dazzling event 402 may finish before the vehicle 100 reaches the ending location 408 associated therewith. For example, if the sunroof dimming system 700 determines that the vehicle 100 deviates from the trajectory 400 (e.g., the vehicle 100 turns from the first road 410 to the second road 412) and/or the route 414, the sunroof dimming system 700 determines that the detected dazzling event 402 is finished (i.e., provides a positive determination). In another example, if the sunroof dimming system 700 determines that the light intensity within the vehicle cabin 114 falls below a threshold light intensity (e.g., due to an obstruction such as a cloud, a building, etc.), the sunroof dimming system 700 determines that the detected dazzling event 402 is finished (i.e., provides a positive determination).

The method 800 of FIG. 8 also includes determining whether the dazzling event is finished (block 818). In some examples, the sunroof dimming system 700 of FIG. 7 determines (e.g., via the data analyzer 708) whether the detected dazzling event 402 is finished based on the check performed in connection with block 816. In some examples, if the sunroof dimming system 700 provides a negative determination (block 818: NO), control of the method 800 returns to block 814. However, if the sunroof dimming system 700 provides a positive determination (block 818: YES), control of the method 800 proceeds to block 820.

The method 800 of FIG. 8 also includes ceasing adjusting dimming of the sunroof panel (block 820). In some examples, the sunroof dimming system 700 of FIG. 7 ceases adjusting dimming (e.g., via the sunroof interface 702) of the sunroof panel 202. For example, the sunroof dimming system 700 controls the panel 202 to change from the second state back to the first state. In some examples, the sunroof dimming system 700 controls the panel 202 to increase the transparency of the primary area 318.

The method 800 of FIG. 8 also includes determining whether to monitor the vehicle for another dazzling event (block 822). In some examples, the sunroof dimming system 700 of FIG. 7 determines (e.g., via the data analyzer 708) whether to monitor the vehicle 100 for another dazzling event such as, for example, the third dazzling event 404. In such examples, if the sunroof dimming system 700 provides a positive determination (e.g., the vehicle 100 is in operation) (block 822: YES), control of the method 800 returns to block 802. On the other hand, if the sunroof dimming system 700 provides a negative determination (e.g., the vehicle 100 is not in operation) (block 822: NO), the method 800 ends.

Although the example method 800 is described in connection with the flow diagram of FIG. 8, one or more other methods of implementing the example sunroof dimming system 700 may alternatively be used. For example, the order of execution of the blocks 802, 804, 806, 808, 810, 812, 814, 816, 818, 820, 822 may be changed, and/or at least some operations of the blocks 802, 804, 806, 808, 810, 812, 814, 816, 818, 820, 822 described may be changed, eliminated, or combined.

FIGS. 9 and 10 are flow diagrams representative of an example method 804 that may be executed to implement the example sunroof dimming system 700 of FIG. 7 to detect a condition associated with the vehicle 100 based on at least some of the data 720, 722, 724, 726. The example method 804 of FIGS. 9 and 10 can be implemented in any of the vehicle 100 of FIGS. 1-4, the controller 102 of FIGS. 1 and 7, and/or the sunroof dimming system 700 of FIG. 7. Example operations of blocks 902, 904, 906, 908, 910, 912, 914, 916, 917, 918, 920, 922 may be used to implement block 804 of FIG. 8. In particular, the example method 804 of FIGS. 9 and 10 is effective in determining whether one or more vehicle occupants will soon be exposed, via the sunroof panel 202, to at least a portion of the external light 306 while the vehicle 100 is moving.

The method 804 of FIG. 9 begins by detecting an observed location of a light source external to the vehicle based on time data (block 902). In some examples, the sunroof dimming system 700 of FIG. 7 detects (e.g., via the data analyzer 708) the first observed location 310 of the light source 304, for example, based at least a portion of the time data 722 corresponding to the time of day.

The method 804 of FIG. 9 also includes detecting an observed location of facial feature of a vehicle occupant based on sensor data (block 904). In some examples, the sunroof dimming system 700 of FIG. 7 detects (e.g., via the data analyzer 708) the second observed location 312 of the facial feature 314 based on at least a portion (e.g., image data) of the sensor data 720. Thus, in some examples, the sunroof dimming system 700 detects the second observed location 312 via the sensor(s) 106 (e.g., one or more cameras) and/or the vehicle system(s) 108 (e.g., a camera monitoring system).

The method 804 of FIG. 9 also includes detecting an observed location of the vehicle based on vehicle positional data (bock 906). In some examples, the sunroof dimming system 700 of FIG. 7 detects (e.g., via the data analyzer 708) the third observed location 316 of the vehicle 100 based on at least portion (e.g., GPS data) at least a portion of the sensor data 720. Thus, in some examples, the sunroof dimming system 700 determines the third location 316 via the sensor(s) 106 (e.g., the GPS locator) and/or the vehicle system(s) 108 (e.g., the GPS and/or the navigation system).

The method 804 of FIG. 9 also includes calculating a trajectory associated with the vehicle based on a predetermined vehicle route and/or road parameter(s) (block 908). In some examples, the sunroof dimming system 700 of FIG. 7 calculates (e.g., via the data analyzer 708) the trajectory 400 associated with the vehicle 100 based on the predetermined vehicle route 414 and/or the shape or curvature, the length, the inclination, etc. of the first road 410 along which the vehicle 100 is moving. In some such examples, the sunroof dimming system 700 determines that the vehicle 100 is traveling along the first road 410 and/or a direction in which the vehicle 100 is traveling based on the third observed location 316 and/or the vehicle positional data stored in the database 710.

The method 804 of FIG. 9 also includes identifying a predicted location and a predicted orientation of the vehicle that correspond to a portion of the trajectory (block 910). In some examples, the sunroof dimming system 700 of FIG. 7 identifies (e.g., via the data analyzer 308) a first predicted location and a first predicted orientation of the vehicle 100 that correspond to a portion of the trajectory 400. For example, the sunroof dimming system 700 identifies one of the first starting location 406, the first ending location 408, or a location defined by the trajectory 400 that is between the first starting location 406 and the first ending location 408. In another example, the sunroof dimming system 700 identifies one of the second starting location 418, the second ending location 420, or a location defined by the trajectory 400 that is between the second starting location 418 and the second ending location 420. In yet another example, the sunroof dimming system identifies the destination 416.

The method 804 of FIG. 10 includes comparing the locations and the orientation to criteria (block 912). In some examples, sunroof dimming system 700 of FIG. 7 compares (e.g., via the data analyzer 708): (1) the first observed location 310 of the light source 304 (i.e., detected in connection with block 902); (2) the second observed location 312 of the facial feature 314 (i.e., detected in connection with block 904); (3) the first predicted location of the vehicle 100 (i.e., identified in connection with block 910); (4) and the first predicted orientation of the vehicle 100 (i.e., identified in connection with block 910) to the criteria 726, which indicates to the sunroof dimming system 700 whether at least one of the dazzling events 300, 402, 404 is likely to occur when the vehicle 100 is at or near the first predicted location.

The method 804 of FIG. 10 also includes determining whether the locations and the orientation satisfy the criteria (block 914). In some examples, the sunroof dimming system 700 of FIG. 7 determines (e.g., via the data analyzer 708) whether the first observed location 310, the second observed location 312, the first predicted location, and the first predicted orientation satisfy the criteria 726 based on the comparison performed in connection with block 912. In some examples, if the sunroof dimming system 700 provides a negative determination (e.g., the first predicted location of the vehicle 100 corresponds to the destination 416) (block 914: NO), control of the method 804 of FIG. 9 proceeds to block 922. On the other hand, if the sunroof dimming system 700 provides a positive determination (e.g., the first predicted location of the vehicle 100 corresponds to one of the first starting location 406, the first ending location 408, or a location defined by the trajectory 400 between these two locations 406, 408) (block 914: YES), control of the method 804 of FIG. 10 proceeds to block 916.

The method 804 of FIG. 10 also includes determining that the vehicle occupant will be exposed, via the sunroof panel, to an external light when the vehicle is at or near the predicted location (block 916). In some examples, in response to the determination in connection with block 914, the sunroof dimming system 700 of FIG. 7 determines (e.g., via the data analyzer 708) that the vehicle occupant 302 will be exposed, via the sunroof panel 202, to at least a portion of the external light 306 when the vehicle 100 is at or near the first predicted location (e.g., 406). As a result, in such examples, the sunroof dimming system 700 determines that a dazzling event (e.g., the second dazzling event 402) will likely occur while the vehicle 100 is following the trajectory 400.

The method 804 of FIG. 10 also includes calculating a distance between the observed location of the vehicle and the predicted location (block 917). In some examples, the sunroof dimming system 700 of FIG. 7 calculates (e.g., via the data analyzer 708) the distance of interest 426 between the third observed location 316 of the vehicle 100 and the first starting location 406.

The method 804 of FIG. 10 also includes calculating when the vehicle will reach the predicted location based on the distance and a vehicle speed (block 918). In some examples, the sunroof dimming system 700 of FIG. 7 calculates (e.g., via the data analyzer 708) when the vehicle 100 will reach the first starting location 406 based on the distance of interest 426 and the speed of the vehicle 100. For example, based on such data, the sunroof dimming system 700 calculates a first example time interval (e.g., 10 seconds, 30 seconds, 60 seconds, etc.) corresponding to when the vehicle 100 will reach the first starting location 406. In this manner, the sunroof dimming system 700 determines that the second dazzling event 402 will occur within a time interval (i.e., a predetermined time interval), which facilitates the operation of block 808 of the method 800 of FIG. 8.

The method 804 of FIG. 10 also includes determining an area of the sunroof panel that will be aligned to the facial feature and the light source when the vehicle is at or near the predicted location (block 920). In some examples, the sunroof dimming system 700 of FIG. 7 determines (e.g., via the data analyzer 708) that the primary area 318 of the sunroof panel 202 that will be aligned to and/or positioned between the facial feature 314 and the light source 304 when the vehicle 100 is at or near the first starting location 406 (i.e., first predicted location), for example, based on at least some of the data 720, 722, 724, 726. For example, the sunroof dimming system 700 determines that the primary portion of 308 of the light 306 will be directed through the third dimming band 504 based on the first location 310 of the light source 304, the second location 312 of the facial feature 314, the first predicted location of the vehicle 100, and the first predicted orientation of the vehicle 100.

The method 804 of FIG. 10 also includes determining whether to analyze a different portion of the trajectory (block 922). In some examples, the sunroof dimming system 700 of FIG. 7 determines (e.g., via the data analyzer 708) whether to analyze a different portion of the trajectory 400, for example, if the one or more portions of the trajectory 400 have not yet been analyzed by the sunroof dimming system 700 for a potential dazzling event. In such examples, if the sunroof dimming system 700 provides a positive determination (block 922: YES), control of the method 804 returns to block 910. That is, in such examples, the sunroof dimming system 700 returns to block 910 to identify a second example predicted location of the vehicle 100 (different from the first predicted location) and a second example predicted orientation of the vehicle 100 (different from the first predicted orientation) that correspond to a different portion of the vehicle trajectory 400. Thus, in some examples, the sunroof dimming system 700 analyzes all portions of the trajectory 400 to detect for potential dazzling event(s). On the other hand, if the sunroof dimming system 700 provides a negative determination (e.g., all portions of the trajectory 400 have been analyzed) (block 922: NO), the example method 804 of FIG. 9 returns to a calling function such as the example method 800 of FIG. 8.

Although the example method 804 is described in connection with the flow diagram of FIGS. 9 and 10, one or more other methods of implementing the example sunroof dimming system 700 may alternatively be used. For example, the order of execution of the blocks 902, 904, 906, 908, 910, 912, 914, 916, 917, 918, 920, 922 may be changed, and/or at least some operations of the blocks 902, 904, 906, 908, 910, 912, 914, 916, 917, 918, 970, 922 described may be changed, eliminated, or combined.

FIG. 11 is a block diagram of an example processor platform 1100 structured to execute instructions to carry out the example methods of FIGS. 8-10 and/or, more generally, to implement the example sunroof dimming system of FIG. 7. For example, the processor platform 1100 can be a personal computer, a server, a mobile device (e.g., a cell phone, a smart phone, a tablet, etc.) or any other type of computing device. According to the illustrated example of FIG. 11, the processor platform 1100 includes a central processing unit (CPU) 1102 (sometimes referred to as a processor), which is hardware (e.g., one or more integrated circuits, one or more logic circuits, one or more microprocessors, etc.). The CPU 1102 of FIG. 11 includes a local memory 1104 such as, for example, a cache. According to the illustrated example of FIG. 11, the CPU 1102 implements the example sensor interface 702, the example user interface 704, the example network interface 706, and the example data analyzer 708 and the example user interface 712.

Coded instruction(s) 1106 to implement the methods of FIGS. 8-10 may be stored in a main memory 1108 of the processor platform 1100. The memory 1108 may include a volatile memory (e.g., random access memory device(s) such as Dynamic Random Access Memory (DRAM)) and a non-volatile memory (e.g., flash memory). Such processes and/or instructions may also be stored on a storage medium disk 1110 associated with the processor platform 1100, such as a hard drive (HDD) or portable storage medium, or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the processor platform 1100 communicates, such as a server or computer.

Further, the claimed advancements may be provided as a utility application, background daemon, or component of an operating system, or combination thereof, executing in conjunction with the CPU 1102 and an operating system such as, for example, Microsoft Windows 7, UNIX, Solaris, LINUX, Apple MAC-OS or any other system(s) known to those skilled in the art.

The hardware elements in order to achieve the processor platform 1100 may be realized by various circuitry elements, known to those skilled in the art. For example, the CPU 1102 may be a Xenon or Core processor from Intel of America or an Opteron processor from AMD of America, or may be other processor types that would be recognized by one of ordinary skill in the art. Alternatively, the CPU 1102 may be implemented on an FPGA, ASIC, PLD or using discrete logic circuits, as one of ordinary skill in the art would recognize. Further, the CPU 1102 may be implemented as multiple processors cooperatively working in parallel to perform the instructions of the inventive processes described above.

In some examples, the processor platform 1100 of FIG. 11 also includes a network controller 1112 such as, for example, an Intel Ethernet PRO network interface card from Intel Corporation of America for interfacing with one or more networks 1114. As can be appreciated, the network(s) 1114 can be one or more public networks (e.g., the Internet), private networks (e.g., a local area network (LAN), a wide area network (WAN), etc.) and/or sub-networks (e.g., a public switched telephone network (PSTN), an integrated services digital network (ISDN), etc.). The network(s) 1114 can also be wired, such as an Ethernet network, or can be wireless such as a cellular network including EDGE, 3G and 4G wireless cellular systems. The wireless network can also be WiFi, Bluetooth, or any other wireless form of communication that is known.

The processor platform 1100 of FIG. 11 includes a general purpose I/O interface circuit 1116 that interfaces and/or otherwise communicates with one or more input devices 1118 and/or one or more output devices 1120. The I/O interface circuit 1116 of FIG. 11 may be implemented as an Ethernet interface, a universal serial bus (USB), a PCI express interface, and/or any other type of standard interface.

The input devices 1118 are connected to the I/O interface 1116 and may include, for example, a keyboard, a mouse, a touchscreen, a button, a microphone, a voice recognition system, a camera, and/or any other suitable device(s) for enabling a person to input data and/or commands to the CPU 1102. As such, in some examples, the I/O interface circuit 1116 typically includes a display controller 1122 such as, for example, a NVIDIA GeForce GTX or Quadro graphics adaptor from NVIDIA Corporation of America for interfacing with a display (e.g., a Hewlett Packard HPL2445w LCD monitor).

The output device(s) 1120 are also connected to the I/O interface circuit 1116 and may include display devices such as, for example, a light-emitting diode (LED), a liquid crystal display, a touchscreen, a printer, a scanner (e.g., an OfficeJet or DeskJet from Hewlett Packard), a speaker, and/or any other device(s) for providing or presenting information (e.g., visual information and/or audible information) to a person. As such, in some examples, the I/O interface circuit includes a sound controller 1124 such as, for example, Sound Blaster X-Fi Titanium from Creative, to interface with a speaker and/or a microphone.

The processor platform 1100 of FIG. 11 also includes a general purpose storage controller 1126 that connects the storage medium disk 1110 with a communication bus 1128. The storage controller 1126 may also control access to the memory 1108. The communication bus 1128 of FIG. 11 may be an ISA, EISA, VESA, PCI, etc. for interconnecting all of the components of the processor platform 1100. For example, the CPU 1102 communicates with the main memory 1108 via the bus 1128.

It will be appreciated that the systems, apparatus, and methods disclosed in the foregoing description provide numerous advantages. Examples disclosed herein automatically detect when external light will be adversely affecting one or more vehicle occupants and adjust dimming associated with a sunroof before such an occurrence, which prevents a driver from being dazzled and/or reduces heat buildup within a vehicle cabin. As a result, disclosed examples improve vehicle safety and/or comfort of the vehicle occupant(s).

Although certain example systems, apparatus, and methods have been disclosed herein, the scope of coverage of this patent is not limited thereto. Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A sunroof dimming system for a vehicle, comprising:
a dimmable panel of a vehicle sunroof; and
a controller operatively coupled to the dimmable panel, the controller configured to:
obtain data during operation of the vehicle;
determine, based on the data, that a vehicle occupant will be exposed to an external light via the dimmable panel when the vehicle is at a first predicted location of a road; and
control the dimmable panel before the vehicle is at the first predicted location to reduce a brightness of the external light that the vehicle occupant will encounter.

2. The sunroof dimming system of claim 1, wherein the dimmable panel includes multiple dimming bands positioned thereon and extending from a first side of the dimmable panel to a second side of the dimmable panel opposite the first side, the controller to control one or more of the dimming bands to change a visual characteristic associated with the dimmable panel.

3. The sunroof dimming system of claim 2, wherein the dimming bands are rectangular.

4. The sunroof dimming system of claim 2, wherein the controller is to generate a dimming gradient via the dimming bands.

5. The sunroof dimming system of claim 2, wherein the dimming bands form a primary area of the panel and one or more secondary areas of the panel different from the primary area, and wherein the controller causes the primary area to be less transparent relative to the one or more secondary areas.

6. An apparatus, comprising:
a sunroof controller, configured to:
determine that a dazzling event will occur while a vehicle is moving based on data associated with the vehicle, the dazzling event corresponding to a vehicle occupant being exposed to an external light via a sunroof panel of the vehicle; and
adjust dimming of the sunroof panel before the dazzling event occurs to prevent the vehicle occupant from being dazzled by the external light.

7. The apparatus of claim 6, wherein the sunroof controller is to:
calculate a trajectory associated with the vehicle;
identify a predicted location of the vehicle that corresponds to a portion of the trajectory, the dazzling event to occur when the vehicle is at the predicted location; and
control the sunroof panel before the vehicle reaches the predicted location.

8. The apparatus of claim 7, wherein the sunroof controller is to calculate the trajectory based on a predetermined route provided by a vehicle GPS or navigation system.

9. The apparatus of claim 7, wherein the sunroof controller is to calculate the trajectory based on a curvature or shape of a road on which the vehicle is moving.

10. The apparatus of claim 7, wherein the sunroof controller is to:
calculate a distance between an observed location of the vehicle and the predicted location of the vehicle;
compare the distance to a threshold distance; and
control the sunroof panel when the distance is below the threshold distance.

11. The apparatus of claim 7, wherein the sunroof controller is to:
determine whether the vehicle deviates from the trajectory during the dazzling event; and
cease adjusting dimming of the sunroof panel if the vehicle deviates from the trajectory.

12. The apparatus of claim 6, wherein the sunroof controller is to:
determine a primary area of the sunroof panel that will be associated with a glare encountered by the vehicle occupant during the dazzling event, the sunroof panel including a secondary area different from the primary area that will not be associated with the glare during the dazzling event; and
dim the primary area by a greater degree relative to the secondary area.

13. The apparatus of claim 12, wherein the sunroof controller is to shift the primary area during the dazzling event based on movement of the vehicle relative to a light source generating the external light.

14. The apparatus of claim 6, wherein the sunroof controller controls the sunroof panel to generate a dimming gradient thereon whereby a transparency of the sunroof panel varies across a portion of the dimming gradient.

15. A tangible machine-readable storage medium comprising instructions that, when executed, cause a processor to at least:
determine that a dazzling event will occur while a vehicle is moving based on data associated with the vehicle, the dazzling event corresponding to a vehicle occupant being exposed to an external light via a sunroof panel of the vehicle; and
adjust dimming of the sunroof panel before the dazzling event occurs to prevent the vehicle occupant from being dazzled by the external light.

16. The tangible machine-readable storage medium of claim 15, wherein the instructions cause the processor to:
calculate a trajectory associated with the vehicle;
identify a predicted location of the vehicle that corresponds to a portion of the trajectory, the dazzling event to occur when the vehicle is at the predicted location; and
control the sunroof panel before the vehicle reaches the predicted location.

17. The tangible machine-readable storage medium of claim 16, wherein the instructions cause the processor to calculate the trajectory based on a predetermined route provided by a vehicle GPS or navigation system.

18. The tangible machine-readable storage medium of claim 16, wherein the instructions cause the processor to calculate the trajectory based on a curvature or shape of a road on which the vehicle is moving.

19. The tangible machine-readable storage medium of claim 16, wherein the instructions cause the processor to:
calculate a distance between an observed location of the vehicle and the predicted location of the vehicle;
compare the distance to a threshold distance; and
control the sunroof panel when the distance is below the threshold distance.

20. The tangible machine-readable storage medium of claim 16, wherein the instructions cause the processor to:
determine whether the vehicle deviates from the trajectory during the dazzling event; and
cease adjusting dimming of the sunroof panel if the vehicle deviates from the trajectory.
